(19) United States
(12) Patent Application Publication
(10) Pub. No.: US 2022/0213604 A1
(43) Pub. Date: Jul. 7, 2022

(54) ELECTROCATALYSTS SYNTHESIZED UNDER CO2 ELECTROREDUCTION AND RELATED METHODS AND USES

(71) Applicants: TOTAL SE, Courbevoie (FR); THE GOVERNING COUNCIL OF THE UNIVERSITY OF TORONTO, Toronto (CA)

(72) Inventors: Yuhang WANG, Toronto (CA); Edward SARGENT, Toronto (CA)

(21) Appl. No.: 17/608,713

(22) PCT Filed: May 6, 2020
(86) PCT No.: PCT/EP2020/062602

§ 371 Date: Nov. 3, 2021

Related U.S. Application Data
(60) Provisional application No. 62/844,482, filed on May 7, 2019.

(30) Foreign Application Priority Data
Sep. 30, 2019 (EP) 19200609.6

(51) Int. Cl. C25B 11/081; C25B 11/032; C25B 11/054; C25D 3/38; C25D 3/46

(52) U.S. Cl. CPC C25B 11/081; C25B 11/032; C25D 3/46; C25D 3/38; C25B 11/054

(57) ABSTRACT

The invention provides an electrocatalyst and a method of preparing a metal catalyst material comprising in-situ electrodeposition of the catalytic metal in the presence of CO₂ and/or CO under electroreduction conditions, wherein the catalytic metal comprising copper (Cu) or silver (Ag) is electrodeposited onto a substrate comprising a gas diffusion layer and wherein the gas diffusion layer includes a metal seed layer disposed thereon, so that the catalytic metal is electrodeposited as an active catalyst layer onto the metal seed layer.

### TECHNICAL FIELD

The technical field generally relates to the synthesis of catalysts and catalytic methods for enhancing reactions, such as catalytic CO₂ electroreduction.

### BACKGROUND

Electrochemical carbon dioxide (CO₂) reduction upgrades CO₂ to value-added renewable fuels and feedstocks. The selective electrosynthesis of C2+ hydrocarbons and oxygenates has attracted recent attention in light of the high market price they command per unit energy input. Today's actual selectivities toward C2+ products curtail system energy efficiency, and hence limit the potential for economically competitive renewable fuels and feedstocks.

Cu(100) is known to be the most active facet for producing C2+ products; however, the predominant exposure is of catalysis-unfavourable facets, limiting activity and selectivity toward desired products. Stabilizing the less-favoured Cu(100) during the formation of polycrystalline Cu catalysts thus requires a kinetic strategy during materials synthesis.

There is a need for improved techniques and catalyst materials for efficient electrochemical CO₂ reduction and related methods and systems of producing chemical compounds.

### SUMMARY

An objective of the invention is to provide a method for the production of a metal catalyst material or electrocatalyst material that overcome one or more of the drawbacks found in prior art. In particular, the invention aims providing catalyst materials and methods of production of said catalyst materials for efficient electrochemical CO₂ reduction and related methods and systems of producing chemical compounds.

According to a first aspect, the invention provides a method of preparing an electrocatalyst being a metal catalyst material comprising in-situ electrodeposition of the catalytic metal in the presence of CO₂ and/or CO under electroreduction conditions, wherein the catalytic metal comprising copper (Cu) or silver (Ag) is electrodeposited onto a substrate comprising a gas diffusion layer.

With preference, the gas diffusion layer includes a metal seed layer disposed thereon, so that the catalytic metal is electrodeposited as an active catalyst layer onto the metal seed layer.

With preference, the one or more following features can be used to further define the method:
The gas diffusion layer includes a metal seed layer disposed thereon and the metal seed layer has a thickness ranging from 5 nm to 70 nm based on thickness sensors in evaporator or sputtering devices; preferably, 25 nm to 60 nm; more preferably, 40 nm to 50 nm.
The gas diffusion layer includes a metal seed layer disposed thereon and the metal seed layer is provided via thermo-evaporation, e-beam evaporation, atomic layer deposition, or magnetron sputtering onto the gas diffusion layer.
The in-situ electrodeposition is performed such that the active catalyst layer has a thickness ranging from about 100 nm to about 1000 nm based on cross-section scanning electron microscopy (SEM); preferably ranging from about 200 nm to about 600 nm.
The catalytic metal is formed from electrodeposition from a catholyte solution comprising a salt of the catalytic metal, at least one complexing agent, and an alkali metal hydroxide; with preference, the salt of the catalytic metal is one or more of sulfate, acetate, nitrate, halides such as bromide, acetylacetonate, perchlorate, hydroxide, carbonate basic, and/or tartrate hydrate of the metal; and/or the complexing agent is one or more of ammonia, ethylenediamine, tartrate acid and/or its salts, citric acid and/or its salts, ethylenediaminetetraacetic acid and/or its salts. Thus, the complexing agent is one or more of ammonia, ethylenediamine, tartrate acid, tartrate acid salts, citric acid, citric acid salts, ethylenediaminetetraacetic acid, ethylenediaminetetraacetic acid salts.
CO₂ is provided at least as a CO₂-containing gas flowing through the catholyte solution; with preference, the CO₂-containing gas is provided at a flow rate ranging from about 10 standard cubic centimeters per minute to about 1000 standard cubic centimeters per minute during the in-situ electrodeposition; with preference ranging from about 30 standard cubic centimeters per minute to about 100 standard cubic centimeters per minute.
the CO₂-containing gas is a CO₂ gas.
The method further comprises providing a constant current for the electrodeposition that is between −0.01 and −10 A cm−2.
The method further comprises providing a constant potential for the electrodeposition that is between from −0.2 and −3 V versus RHE.

In an embodiment, the method further comprises:
providing the catholyte in a cathodic chamber;
providing an anolyte in an anodic chamber separated from the cathodic chamber via a separator;
providing a counter electrode in the anodic chamber;
feeding the CO₂ into the cathodic chamber during the electrodeposition; and
providing a potential for the electrodeposition;

With preference, the anolyte is provided with the same amount of alkali metal hydroxides as the catholyte; and/or the counter electrode comprises a material selected from one or more of Ni, Pt and/or Au.

With preference, the separator comprises an anion-exchange membrane and/or a Nafion membrane.

For example, the catalytic metal comprises copper (Cu) or consists of copper (Cu).

For example, the catalytic metal comprises silver (Ag) or consists of silver (Ag); with preference, the catalytic metal comprises silver (Ag) and is electrodeposited as Ag₂O.

According to a second aspect, the invention provides a method of preparing an electrocatalyst comprising:
preparing a catalyst precursor;
disposing the catalyst precursor onto a substrate comprising a gas diffusion layer; and
subjecting the deposited catalyst precursor to electroreduction conditions in the presence of CO₂ and/or CO to form the electrocatalyst on the substrate.

For example, the catalyst precursor comprises Ag₂O and the electrocatalyst comprises silver (Ag) including exposed Ag(110) facets; preferably the catalyst precursor is prepared by mixing AgNO₃ with KOH to form Ag₂O particles more preferably the Ag₂O particles are spray-coated onto the substrate and/or Ag₂O particles are provided with a mass loading of at least 0.3 mg cm−2 on the substrate.

With preference, the electroreduction conditions comprise a constant current of about −0.15 A cm−2 to about −0.25 A cm−2 for at least 30 seconds.

For example, the catalyst precursor comprises a copper (Cu) oxide and the electrocatalyst comprises Cu including exposed Cu(100) facets; preferably Cu oxide particles are spray-coated onto the substrate.

In an embodiment, the method according to the second aspect is a method according to the first aspect.

According to a third aspect, the invention provides an electrocatalyst for electroreduction of CO₂ and/or CO to generate products, the electrocatalyst comprising a metal catalyst material being in situ faceted to include exposed active facets presenting a highest selectivity of the corresponding metal for production of a target hydrocarbon product from electroreduction of CO₂ and/or CO, wherein the metal catalyst material comprises copper (Cu) and the exposed active facets are Cu(100) facets; with preference the electrocatalyst is produced according to the method of the first aspect.

In a preferred embodiment, the Cu catalyst material has a crystal size between about 15 nm and about 100 nm, or between about 20 nm and about 60 nm, according to scanning electron microscopy (SEM).

In a preferred embodiment, the Cu catalyst material comprises exposed Cu(100) facets corresponding to an OH− electroadsorption charge distribution Cu(100)/Cu(111) ratio of at least 1.0, preferably at least 1.1, more preferably at least 1.2 and even more preferably at least 1.3 as determined by OH− electroadsorption.

In a preferred embodiment, the Cu catalyst material is formed as an active catalyst layer on a Cu seed layer; with preference, the Cu seed layer is disposed on a gas diffusion layer.

In a preferred embodiment, the Cu catalyst material is formed as an active catalyst layer on a Cu seed layer and the active catalyst layer has a thickness between about 100 nm and about 1000 nm, or between about 200 nm and about 600 nm according to scanning electron microscopy (SEM).

In a preferred embodiment, the Cu catalyst material is formed as an active catalyst layer on a Cu seed layer and the seed layer has a thickness of about 5 nm to 70 nm, 25 nm to 60 nm, or 40 nm to 50 nm based on thickness sensors in evaporator or sputtering devices.

In a preferred embodiment, the Cu catalyst material is formed as an active catalyst layer on a Cu seed layer and the seed layer is provided via thermo-evaporation, e-beam evaporation, atomic layer deposition, or magnetron sputtering.

In a preferred embodiment, the Cu catalyst material consists of Cu.

According to a fourth aspect, the invention provides an electrocatalyst for electroreduction of CO₂ and/or CO to generate products, the electrocatalyst comprising a metal catalyst material being in situ faceted to include exposed active facets presenting a highest selectivity of the corresponding metal for production of a target hydrocarbon product from electroreduction of CO₂ and/or CO, wherein the metal catalyst material comprises silver (Ag) and the exposed active facets are Ag(110) facets; with preference, the Ag catalyst material has exposed Ag(110) facets corresponding to:
(i) an area of at least 2.5, 2.6, 2.7, 2.8, or 2.9 cm² Ag(110) facets normalized to 1 cm2 according to electrochemical hydroxide adsorption;
(ii) an at least 1.5-fold increase in the area of Ag(110) facets compared to a corresponding catalyst synthesized using H₂ evolution only by replacing the CO₂ with N₂; and/or
(iii) an amount enabling electroreduction of CO₂ into CO with Faradaic efficiency for CO of at least about 75%, at least about 80%, or at least about 83%, and half-cell CO power conversion efficiency of 54% at 260 mA cm⁻².

The invention also provides an electrocatalyst for electroreduction of CO2 to produce CO, the electrocatalyst being according to the second or to the third aspect, the electrocatalyst comprising a metal (M) catalyst material having exposed facets comprising (a) exposed target facets M(T) that provide the highest favourability for catalyzing production of C2+ products from CO2 by electroreduction of CO2 and (b) exposed secondary facets M(S) that provide lower favourability for catalyzing production of C2+ products from CO₂ by electroreduction of CO2, wherein the electrocatalyst comprises a ratio of M(T)/M(S) of at least 1.2 as determined by OH− electroadsorption and wherein M is Cu or Ag; with preference, the electrocatalyst is prepared according to the first aspect.

According to a fifth aspect, the invention provides the use of the electrocatalyst as defined in the third or fourth aspect and/or as prepared using the method as defined in the first aspect, to catalyse electroreduction conversion of CO₂ into at least one hydrocarbon product.

For example, the electrocatalyst is Cu based and the carbon compounds comprise ethylene and/or C2+ carbon products.

For example, the electrocatalyst is Ag based, the gas is CO₂ and the carbon compounds comprise CO.

According to a sixth aspect, the invention provides a process for electrochemical production of a carbon compound from CO₂ and/or CO, comprising:
contacting CO₂ and/or CO gas and an electrolyte with an electrode comprising the electrocatalyst as defined in any one of the third or fourth aspect and/or as prepared using the method as defined in the first aspect and/or second aspect, such that the CO₂ and/or CO contacts the electrocatalyst;
applying a voltage to provide a current density to cause the CO₂ and/or CO gas contacting the electrocatalyst to be electrochemically converted into the carbon compound; and
recovering the carbon compound.

For example, the electrocatalyst is Cu based and the carbon compounds comprise ethylene and/or C2+ carbon products.

For example, the electrocatalyst is Ag based, the gas is CO₂ and the carbon compounds comprise CO.

According to a seventh aspect, the invention provides for a system for CO₂ electroreduction to produce carbon compounds, comprising:
an electrolytic cell configured to receive a liquid electrolyte and CO₂ and/or CO gas;
an anode;
a cathode comprising an electrocatalyst as defined in the third or fourth aspect and/or as prepared using the method as defined in the first aspect and/or the second aspect; and
a voltage source to provide a current density to cause the CO₂ and/or CO gas contacting the electrocatalyst to be electrochemically converted into the carbon compound.

For example, the electrocatalyst is Cu based and the carbon compounds comprise ethylene and/or C2+ carbon products.

For example, the electrocatalyst is Ag based, the gas is CO₂ and the carbon compounds comprise CO.

According to a eight aspect, the invention provides a precursor composition for making an electrocatalyst according to the third or to the fourth aspect, using electroreduction conditions in the presence of CO₂ and/or CO to form the electrocatalyst on a substrate, the precursor comprising:
an aqueous medium that is preferably deionized water;
metal ions dissolved in the aqueous medium and provided by a metal salt; and
a complexing agent in the aqueous medium for stabilizing the metal ions; and
   wherein the precursor composition is formulated such that the electroreduction conditions in the presence of CO2 and/or CO enables the metal ions to deposit on the substrate to have exposed target facets.

With preference, the one or more following features can be used to further define the catalyst precursor:
the metal salt is one or more of sulfate, acetate, nitrate, halides such as bromide, acetylacetonate, perchlorate, hydroxide, carbonate basic, and/or tartrate hydrate of the metal; and/or
the aqueous medium is deionized water; and/or
the metal is Cu and the Cu ions are provided by a Cu salt that includes CuBr₂; and/or
the metal salt is provided at a concentration of 0.05 to 0.15 M, 0.08 to 0.12 M, or 0.1 M; and/or
the Cu salt is provided at a concentration of 0.05 to 0.15 M, 0.08 to 0.12 M, or 0.1 M; and/or
the complexing agent comprises one or more of ammonia, ethylenediamine, tartrate acid, tartrate acid salts, citric acid, citric acid salts, ethylenediaminetetraacetic acid, ethylenediaminetetraacetic acid salts; with preference, the complexing agent comprises tartrate acid salts being sodium tartrate; and/or
the complexing agent is provided at a concentration between 0.1 and 0.3; between 0.15 and 0.25, or between 0.18 and 0.22, or about 0.2
the complexing agent is provided at a concentration that is greater than the concentration of the metal salt and optionally 1.5 to 3 times greater; and/or
further comprising one or more alkali metal hydroxide with preference, the alkali metal hydroxide comprises KOH and/or the alkali metal hydroxide is provided in a concentration between 1 to 10 M.

According to an ninth aspect, the invention provides a method of reactivating an electrocatalyst that has operated under electroreduction conditions, comprising:
adding a precursor composition to the catholyte, the precursor composition comprising metal ions or a metal salt to form the metal ions, a complexing agent for stabilizing the metal ions dissolved in the catholyte, thereby forming a reactivation catholyte;
applying a constant potential or current to the electrocatalyst in the presence of CO₂ and/or CO under electroreduction conditions to cause electrodeposition of at least a portion of the metal ions onto the electrocatalyst to form a catalytic metal thereon.

With preference, the one or more following features can be used to further define the method:
the CO₂ is provided at least as a CO₂-containing gas flowing through the catholyte solution; and/or
the CO₂ is provided at a flow rate ranging from about 10 standard cubic centimeters per minute to about 1000 standard cubic centimeters per minute during the in-situ electrodeposition, with preference ranging from about 30 standard cubic centimeters per minute to about 100 standard cubic centimeters per minute; and/or
the CO₂-containing gas is a CO₂ gas; and/or
constant current is provided for the electrodeposition that is between −0.01 and −10 A cm⁻² and/or wherein constant potential for the electrodeposition that is between from −0.2 and −3 V versus RHE; and/or
the electrodeposition for reactivation is performed for about 10 seconds to about 600 seconds; and/or
the precursor composition according to the eight aspect is added to or used as the catholyte; and/or
the electrodeposition for reactivation is performed for at least 10 seconds, at least 20 seconds, at least 40 seconds, or at least 60 seconds; and/or
the metal ions are Cu2+ cations; and/or
further comprising preparing a precursor mixture, directly adding the precursor mixture to the catholyte, operating under electroreduction conditions to produce C2+ hydrocarbons while reactivating the electrocatalyst.

In a preferred embodiment, the catholyte is in a cathodic chamber; an anolyte is in an anodic chamber separated from the cathodic chamber via a separator; electrodes are in the cathodic and anodic chambers respectively; and the CO₂ is fed into the cathodic chamber during the electrodeposition for reactivation with preference:
i) the anolyte is provided with the same amount of alkali metal hydroxides as the catholyte; and/or
ii) the electrode in the anodic chamber comprises a material selected from one or more of Ni, Pt and/or Au; and/or
iii) the separator comprises an anion-exchange membrane or a Nafion membrane.

Various aspects, implementations and features of this technology are described in the claims, description, and drawings.

### DESCRIPTION OF DRAWINGS

FIG. 1 is a representation of in situ electrodeposition of Cu and formation of Cu(100) facets.

FIG. 2 is another representation of in situ electrodeposition of Cu and formation of Cu(100) facets.

FIG. 3. Density Function Theory calculations. (a) Energy profiles of CO dimerization on Cu(111), Cu(100), and Cu(111). (b) Surface energy changes with the surface coverages of CO₂RR (assuming same coverages for all the 4 intermediates) and HER intermediates (c) Adsorption energies of four intermediates on three facets of Cu. Wulff construction clusters of Cu (d) without adsorption and with adsorption of (e-f) CO₂RR and (g-h) HER intermediates.

FIG. 4. Intermediate adsorption engineers Cu facets. (a) The time-dependent morphological change of Cu—CO₂ (upper arrows) and Cu-HER (lower arrows). The scale bars are 100 nm for the evaporated Cu seeds and 10 sec samples, 200 nm for the 60 sec Cu samples, (b, c) Representative HRTEM and dark-field TEM images of Cu—CO₂-60 and Cu-HER-20. The scale bars are 5 nm (d, e) The surface area and ratio of Cu(100) and Cu(111) facets quantified by OH⁻ electroadsorption. (f) Local pH modeling during catalyst growth.

FIG. 5. Operando analysis of the catalyst formation. (a, b) Fourier transformed operando hXAS spectra of the formation of intermediate Cu—CO₂ and Cu-HER with respect to time. (c) Ratio of metallic Cu to Cu precursor over the course of catalyst formation. (d) Charge distribution during the electrochemical catalyst synthesis.

FIG. 6. CO₂ electroreduction performance. (a) j-V plots of CO₂RR and C₂₊ product partial current density vs. potential (with 90% iR correction) on Cu—CO₂ and Cu-HER in 10 M KOH, respectively. (b) Reaction kinetics analysis of the CO₂ electroreduction on Cu—CO₂ and Cu-HER. (c) The highest Faradaic efficiency for C₂₊ products on Cu—CO₂ and Cu-HER, respectively. (d) Faradaic efficiency for each CO₂RR product and H₂ on Cu—CO₂ at various potential ranging from −0.27 to −0.56 V vs. RHE in 10 M KOH. (e) The comparison of C₂₊ and CO Faradaic efficiency on the different electrocatalysts in 10 M KOH.

FIG. 7. CO₂ electroreduction on PTFE/carbon/graphite-based gas diffusion layer. (a) j-V plots of C₂H₄ and C₂+ product partial current density vs. potential (with 90% iR correction) on Cu—CO₂-60 and Cu-HER-20 in 7 M KOH, respectively. (b) Electrochemical active surface area (ECSA) normalized C₂H₄ and C₂₊ product partial current density. (c) Faradaic efficiency for each CO₂RR product and H₂ on Cu—CO₂-60 at various potential ranging from −0.38 to −0.74 V vs. RHE in 7 M KOH. (d) Comparison of C₂H₄ and C₂₊ half-cell power conversion efficiency (PCE) on Cu—CO₂-60 and Cu-HER-20 in the current density range of 130 to 780 mA cm⁻². (e) Comparison of C₂H₄, C₂+ and CO Faradaic efficiency on Cu—CO₂-60 and Cu-HER-20 catalysts in 7 M KOH. (f) Stability comparison of systems with and without adding precursor to catholyte.

FIG. 8. The electrodeposition of Cu catalysts in a CO₂ flow cell. The potential vs. time (V-t) plots of the electrodeposition of Cu—CO₂ and Cu-HER at the current density of 400 mA cm⁻².

FIG. 9. Cross-section SEM images of Cu—CO₂ catalysts deposited in 10 and 60 sec. Cross-section secondary electron (left) and backscattered electron (right) SEM images of Cu—CO₂ catalysts on GDL made in 10 (a) and 60 sec (b).

FIG. 10. Cross-section SEM images of Cu-HER catalysts deposited in 10 and 60 sec. Cross-section secondary electron (left) and backscattered electron (right) SEM images of Cu-HER made in 10 (a) and 60 sec (b).

FIG. 11. SEM images of Cu-HER catalysts deposited in 20 sec. Top-view (a) and cross-section (b) SEM images of Cu-HER made in 20 sec. The left image in b: Secondary electron image. The right image in b: backscattered electron image.

FIG. 12. The crystallinity of Cu—CO₂ and Cu-HER catalysts. XRD patterns of the 60 sec Cu—CO₂, 20 sec Cu-HER and bare GDL.

FIG. 13. Analysis of the surface structure of the electrodeposited Cu. (a-c) OH⁻ adsorption profiles on the Cu with different electrodeposition durations at the sweep rate of 0.1 V s⁻¹. (d) OH⁻ adsorption profiles on Cu(111) and Cu(100) single crystal substrates at the sweep rate of 0.1 V s⁻¹. The OH⁻ adsorption charge on Cu(111) and Cu(100) is 2.16 and 8.22 μC cm⁻².

FIG. 14. The evidence for intermediate adsorption. Potential dependent operando Raman spectra obtained on Cu—CO₂ catalysts made in 60 sec. Peaks located at 285 and 370 cm⁻¹ are corresponding to the Cu—CO bond.

FIG. 15. Liquid products from CO₂ electroreduction. Representative H-NMR spectrum of the electrolyte after electrochemical CO₂ reduction in 10 M KOH. Inset: enlarged images to show the position of each liquid product.

FIG. 16. CO₂RR performance on Cu-HER catalysts. Faradaic efficiency for each CO₂RR product and H₂ at various potential ranging from −0.27 to −0.59 V vs. RHE on Cu-HER catalysts in 10 M KOH.

FIG. 17. ECSA measurements of Cu—CO₂ and Cu-HER catalysts on GDL. (a, b) The cyclic voltammetry profiles obtained on Cu—CO₂ and Cu-HER catalysts at the sweep rates of 20, 40, 60, 80 and 100 mV s⁻¹, respectively. (c) The determination of double layer capacitance for each catalysts. (d) The comparison of surface roughness factors. The double layer capacitance of electropolished Cu foil was obtained from previous report

FIG. 18. X-ray photoelectron spectra. The Cu 2p and O 1s XPS depth profiles of Cu—CO₂ (a, b) and Cu-HER (c, d).

FIG. 19. The Cu oxidation states of Cu—CO₂ catalysts under operation condition. (a, b) Operando hXAS spectra and the Fourier transform results of Cu—CO₂ during the first 63 sec of CO₂RR operation. (c) The corresponding ratio of metallic Cu.

FIG. 20. The Cu oxidation states of Cu-HER catalysts under operation condition. (a, b) Operando hXAS spectra and the Fourier transform results of Cu-HER during the first 63 sec of CO₂RR operation. (c) The corresponding ratio of metallic Cu.

FIG. 21. Surface structural analysis of the catalysts after CO₂RR test. (a) OH⁻ adsorption profiles on Cu—CO₂-60 and Cu-HER-20 catalysts after 1000 sec CO₂ electroreduction test. (b, c) The surface area and ratio of Cu(100) and Cu(111) of the same Cu catalysts before and after CO₂ electroreduction.

FIG. 22. Ag catalysts synthesized under CO₂ electroreduction condition. (a-c) SEM images of Ag₂O, Ag—CO₂ and Ag-HER catalysts. (d, e) The cyclic voltammetry profiles obtained on Ag—CO₂ and Ag-HER catalysts at the sweep rates of 20, 40, 60, 80 and 100 mV s⁻¹, respectively. (f) The determination of double layer capacitance for each Ag catalysts. (g) OH⁻ adsorption profiles on Ag—CO₂ and Ag-HER. The oxidation peak is assigned to the formation of monolayer of Ag₂O on Ag(110). (h) OH⁻ electroadsorption charge on Ag(110) for each catalysts, and related area for Ag(110) facets by assuming the charge is 134.4 μC cm⁻² for the formation of monolayer of Ag₂O on Ag(110). (i) The highest Faradaic efficiency for CO₂RR on Ag—CO₂ and Ag-HER, respectively.

### DETAILED DESCRIPTION

Preferred embodiments of this invention are set herein below. Each statement and embodiment of the invention so defined may be combined with any other embodiments unless clearly indicated to the contrary. In particular, any feature/embodiment indicated as being preferred or advantageous may be combined with any other feature (i.e. statement) or features (i.e. statements) or embodiments indicated as being preferred or advantageous. Hereto, the present invention is in particular captured by any one or any combination of one or more of the below numbered aspects and statements 1 to 91 with any other statement and/or embodiments.

In a statement 1, the invention provides a method of preparing a metal catalyst material comprising in situ electrodeposition of the catalytic metal in the presence of CO₂ and/or CO under electroreduction conditions, wherein the catalytic metal is electrodeposited onto a substrate comprising a gas diffusion layer.

In a statement 2, the invention provides the method of statement 1, wherein the catalytic metal comprises copper (Cu) or silver (Ag).

In a statement 3, the invention provides the method of statement 1 or 2, wherein the gas diffusion layer includes a metal seed layer disposed thereon, and the catalytic metal is electrodeposited as an active catalyst layer onto the metal seed layer.

In a statement 4, the invention provides the method of statement 3, wherein the metal seed layer has a thickness ranging from 5 nm to 70 nm, 25 nm to 60 nm, or 40 nm to 50 nm based on thickness sensors in evaporator or sputtering devices.

In a statement 5, the invention provides the method of statement 3 or 4, wherein the in situ electrodeposition is performed such that the active catalyst layer has a thickness ranging from about 100 nm to about 1000 nm, or ranging from about 200 nm to about 600 nm, based on cross-section scanning electron microscopy (SEM).

In a statement 6, the invention provides the method of any one of statements 3 to 5, wherein the metal seed layer is provided via thermo-evaporation, e-beam evaporation, atomic layer deposition, or magnetron sputtering onto the gas diffusion layer.

In a statement 7, the invention provides the method of any one of statements 1 to 6, wherein the catalytic metal is formed from electrodeposition from a catholyte solution comprising a salt of the catalytic metal, at least one complexing agent, and an alkali metal hydroxide.

In a statement 8, the invention provides the method of statement 7, wherein the salt of the catalytic metal is one or more of sulfate, acetate, nitrate, halides such as bromide, acetylacetonate, perchlorate, hydroxide, carbonate basic, and/or tartrate hydrate of the metal.

In a statement 9, the invention provides the method of statement 7 or 8, wherein the complexing agent is one or more of ammonia, ethylenediamine, tartrate acid and/or its salts, citric acid and/or its salts, ethylenediaminetetraacetic acid and/or its salts.

In a statement 10, the invention provides the method of any one of statements 7 to 9, wherein the CO₂ is provided at least as a CO2-containing gas flowing through the catholyte solution.

In a statement 11, the invention provides the method of statement 10, wherein the CO2-containing gas is provided at a flow rate ranging from about 10 standard cubic centimeters per minute to about 1000 standard cubic centimeters per minute during the in-situ electrodeposition, with preference ranging from about 30 standard cubic centimeters per minute to about 100 standard cubic centimeters per minute.

In a statement 12, the invention provides the method of statement 11, wherein the CO₂-containing gas is a CO₂ gas.

In a statement 13, the invention provides the method of any one of statements 1 to 12, further comprising providing a constant current for the electrodeposition.

In a statement 14, the invention provides the method of statement 13, wherein the constant current is between −0.01 and −10 A cm⁻².

In a statement 15, the invention provides the method of any one of statements 1 to 12, further comprising providing a constant potential for the electrodeposition.

In a statement 16, the invention provides the method of statement 15, wherein the constant potential is between from −0.2 and −3 V versus RHE.

In a statement 17, the invention provides the method of any one of statements 1 to 16, wherein the in-situ electrodeposition is performed for about 10 seconds to about 600 seconds.

In a statement 18, the invention provides the method of any one of statements 1 to 16, wherein the in-situ electrodeposition is performed for at least 10 seconds, at least 20 seconds, at least 40 seconds, or at least 60 seconds.

In a statement 19, the invention provides the method of any one of statements 1 to 18, further comprising:
providing the catholyte in a cathodic chamber;
providing an anolyte in an anodic chamber separated from the cathodic chamber via a separator;
providing a counter electrode in the anodic chamber;
feeding the CO₂ into the cathodic chamber during the electrodeposition; and
providing a potential for the electrodeposition.

In a statement 20, the invention provides the method of statement 19, wherein the anolyte is provided with the same amount of alkali metal hydroxides as the catholyte.

In a statement 21, the invention provides the method of statement 19 or 20, wherein the counter electrode comprises a material selected from one or more of Ni, Pt and/or Au.

In a statement 22, the invention provides the method of any one of statements 19 to 21, wherein the separator comprises an anion-exchange membrane.

In a statement 23, the invention provides the method of any one of statements 19 to 22, wherein the separator comprises a Nafion membrane.

In a statement 24, the invention provides the method of any one of statements 1 to 23, wherein the catalytic metal comprises copper (Cu) or consists of copper (Cu).

In a statement 25, the invention provides the method of any one of statements 1 to 23, wherein the catalytic metal comprises silver (Ag) or consists of silver (Ag).

In a statement 26, the invention provides the method of statement 25, wherein the catalytic metal comprises silver (Ag) and is electrodeposited as Ag₂O.

In a statement 27, the invention provides a method of preparing an electrocatalyst comprising:
preparing a catalyst precursor;
disposing the catalyst precursor onto a substrate comprising a gas diffusion layer; and
subjecting the deposited catalyst precursor to electroreduction conditions in the presence of CO₂ and/or CO to form the electrocatalyst on the substrate.

In a statement 28, the invention provides the method of statement 27, wherein the catalyst precursor comprises Ag₂O and the electrocatalyst comprises silver (Ag) including exposed Ag(110) facets.

In a statement 29, the invention provides the method of statement 28, wherein the catalyst precursor is prepared by mixing AgNO₃ with KOH to form Ag₂O particles.

In a statement 30, the invention provides the method of statement 29, wherein the Ag₂O particles are spray-coated onto the substrate.

In a statement 31, the invention provides the method of statement 29 or 30, wherein the Ag₂O particles are provided with a mass loading of at least 0.3 mg cm⁻² on the substrate.

In a statement 32, the invention provides the method of any one of statements 28 to 31, wherein the electroreduction conditions comprise a constant current of about −0.15 A cm⁻² to about −0.25 A cm⁻² for at least 30 seconds.

In a statement 33, the invention provides the method of statement 27, wherein the catalyst precursor comprises a copper (Cu) oxide and the electrocatalyst comprises Cu including exposed Cu(100) facets.

In a statement 34, the invention provides the method of statement 33, wherein Cu oxide particles are spray-coated onto the substrate.

In a statement 35, the invention provides the method of any one of statements 27 to 34, further comprising one or more features of any one of statements 1 to 26.

In a statement 36, the invention provides an electrocatalyst for electroreduction of CO₂ and/or CO to generate products, the electrocatalyst comprising a metal catalyst material being in situ faceted to include exposed active facets presenting a highest selectivity of the corresponding metal for production of a target hydrocarbon product from electroreduction of CO₂ and/or CO.

In a statement 37, the invention provides the electrocatalyst of statement 36, wherein the target hydrocarbon product is CO or C2+ hydrocarbons.

In a statement 38, the invention provides the electrocatalyst of any one of statements 36 to 39, prepared using the method as defined in any one of statements 1 to 35.

In a statement 39, the invention provides the electrocatalyst of statement 36, wherein the metal catalyst material comprises copper (Cu) and the exposed active facets are Cu(100) facets.

In a statement 40, the invention provides the electrocatalyst of statement 39, wherein the Cu catalyst material has a crystal size between about 15 nm and about 100 nm, or between about 20 nm and about 60 nm, according to scanning electron microscopy (SEM).

In a statement 41, the invention provides the electrocatalyst of statement 39 or 40, wherein the Cu catalyst material comprises exposed Cu(100) facets corresponding to an OH− electroadsorption charge distribution Cu(100)/Cu(111) ratio of at least 1, at least 1.1, at least 1.2 or at least 1.3 as determined by OH− electroadsorption.

In a statement 42, the invention provides the electrocatalyst of any one of statements 39 to 41, wherein the Cu catalyst material comprises exposed Cu(100) facets corresponding to at least double compared to a corresponding catalyst synthesized using H₂ evolution only by replacing the CO₂ with N₂ gas.

In a statement 43, the invention provides the electrocatalyst of any one of statements 39 to 42, wherein the Cu catalyst material comprises exposed Cu(100) facets in an amount enabling electroreduction of CO₂ into C2+ products with Faradaic efficiency for C2+ products of at least about 80%, at least about 85%, or at least about 90%, at a C2+ partial current density of 200 mA cm⁻².

In a statement 44, the invention provides the electrocatalyst of any one of statements 39 to 43, wherein the Cu catalyst material comprises exposed Cu(100) facets in an amount enabling electroreduction of CO₂ into C2+ products with Faradaic efficiency for ethylene of at least about 50%, at least about 55%, or at least about 60%, at a C2+ partial current density of 200 mA cm⁻².

In a statement 45, the invention provides the electrocatalyst of any one of statements 39 to 44, wherein the Cu catalyst material consists of Cu.

In a statement 46, the invention provides the electrocatalyst of any one of statements 39 to 45, wherein the Cu catalyst material is formed as an active catalyst layer on a Cu seed layer.

In a statement 47, the invention provides the electrocatalyst of statement 46, wherein the Cu seed layer is disposed on a gas diffusion layer.

In a statement 48, the invention provides the electrocatalyst of statement 46 or 47, wherein the active catalyst layer has a thickness between about 100 nm and about 1000 nm, or between about 200 nm and about 600 nm according to scanning electron microscopy (SEM).

In a statement 49, the invention provides the electrocatalyst of any one of statements 46 to 48, wherein the seed layer has a thickness of about 5 nm to 70 nm, 25 nm to 60 nm, or 40 nm to 50 nm based on thickness sensors in evaporator or sputtering devices.

In a statement 50, the invention provides the electrocatalyst of any one of statements 46 to 49, wherein the seed layer is provided via thermo-evaporation, e-beam evaporation, atomic layer deposition, or magnetron sputtering.

In a statement 51, the invention provides the electrocatalyst of statement 36, wherein the metal catalyst material comprises silver (Ag) and the exposed active facets are Ag(110) facets.

In a statement 52, the invention provides the electrocatalyst of statement 51, wherein the Ag catalyst material has exposed Ag(110) facets corresponding to: (i) an area of at least 2.5, 2.6, 2.7, 2.8, or 2.9 cm2 Ag(110) facets normalized to 1 cm2 according to electrochemical hydroxide adsorption; (ii) an at least 1.5-fold increase in the area of Ag(110) facets compared to a corresponding catalyst synthesized using H₂ evolution only by replacing the CO₂ with N₂; and/or (iii) an amount enabling electroreduction of CO₂ into CO with Faradaic efficiency for CO of at least about 75%, at least about 80%, or at least about 83%, and half-cell CO power conversion efficiency of 54% at 260 mA cm⁻².

In a statement 53, the invention provides an electrocatalyst for electroreduction of CO₂ to produce CO, the electrocatalyst comprising a metal (M) catalyst material having exposed facets comprising (a) exposed target facets M(T) that provide the highest favourability for catalyzing production of C2+ products from CO₂ by electroreduction of CO₂ and (b) exposed secondary facets M(S) that provide lower favourability for catalyzing production of C2+ products from CO₂ by electroreduction of CO_{2,} wherein the electrocatalyst comprises a ratio of M(T)/M(S) of at least 1.2 as determined by OH− electroadsorption.

In a statement 54, the invention provides the electrocatalyst of statement 53, wherein M is optionally Cu or Ag.

In a statement 55, the invention provides the electrocatalyst of statement 53, further comprising one or more features as defined in any one of statements 36 to 52 or made by the method as defined in any one of statements 1 to 35.

In a statement 56, the invention provides the use of the electrocatalyst as defined in any one of statements 36 to 55 or as prepared using the method as defined in any one of statements 1 to 35, to catalyse electroreduction conversion of CO₂ into at least one hydrocarbon product.

In a statement 57, the invention provides a process for electrochemical production of a carbon compound from CO₂ and/or CO, comprising:
contacting CO₂ and/or CO gas and an electrolyte with an electrode comprising the electrocatalyst as defined in any one of statements 36 to 55 or as prepared using the method as defined in any one of statements 1 to 35, such that the CO₂ and/or CO contacts the electrocatalyst;
applying a voltage to provide a current density to cause the CO₂ and/or CO gas contacting the electrocatalyst to be electrochemically converted into the carbon compound; and
recovering the carbon compound.

In a statement 58, the invention provides a system for CO₂ electroreduction to produce carbon compounds, comprising:
an electrolytic cell configured to receive a liquid electrolyte and CO₂ and/or CO gas;
an anode;
a cathode comprising an electrocatalyst as defined in any one of statements 36 to 55 or as prepared using the method as defined in any one of statements 1 to 35; and
a voltage source to provide a current density to cause the CO₂ and/or CO gas contacting the electrocatalyst to be electrochemically converted into the carbon compound.

In a statement 59, the invention provides the use, process or system of any one of statements 56 to 58, wherein the electrocatalyst is Cu based and the carbon compounds comprise ethylene and/or C2+ carbon products, and/or wherein the electrocatalyst is Ag based, the gas is CO₂ and the carbon compounds comprise CO.

In a statement 60, the invention provides a precursor composition for making an electrocatalyst using electroreduction conditions in the presence of CO₂ and/or CO to form the electrocatalyst on a substrate, the precursor comprising:
an aqueous medium;
metal ions dissolved in the aqueous medium and provided by a metal salt; and
a complexing agent in the aqueous medium for stabilizing the metal ions; and wherein the precursor composition is formulated such that the electroreduction conditions in the presence of CO₂ and/or CO enables the metal ions to deposit on the substrate to have exposed target facets.

In a statement 61, the invention provides the precursor composition of statement 60, wherein the aqueous medium is deionized water.

In a statement 62, the invention provides the method of statement 60 or 62, wherein the metal salt is one or more of sulfate, acetate, nitrate, halides such as bromide, acetylacetonate, perchlorate, hydroxide, carbonate basic, and/or tartrate hydrate of the metal.

In a statement 63, the invention provides the precursor composition of any one of statements 60 to 62, wherein the metal is Cu.

In a statement 64, the invention provides the precursor composition of statement 63, wherein the Cu ions are provided by a Cu salt that includes CuBr₂.

In a statement 65, the invention provides the precursor composition of statement 63 or 64, wherein the Cu salt is provided at a concentration of 0.05 to 0.15 M, 0.08 to 0.12 M, or 0.1 M.

In a statement 66, the invention provides the precursor composition of any one of statements 60 to 62, wherein the metal salt is provided at a concentration of 0.05 to 0.15 M, 0.08 to 0.12 M, or 0.1 M.

In a statement 67, the invention provides the precursor composition of any one of statements 60 to 66, wherein the complexing agent comprises one or more of ammonia, ethylenediamine, tartrate acid and/or its salts, citric acid and/or its salts, ethylenediaminetetraacetic acid and/or its salts.

In a statement 68, the invention provides the precursor composition of statement 67, wherein the complexing agent comprises sodium tatrate.

In a statement 69, the invention provides the precursor composition of any one of statements 60 to 68, wherein the complexing agent is provided at a concentration between 0.1 and 0.3, between 0.15 and 0.25, or between 0.18 and 0.22, or about 0.2; and/or at a concentration that is greater than the concentration of the metal salt and optionally 1.5 to 3 times greater.

In a statement 70, the invention provides the precursor composition of any one of statements 60 to 69, further comprising one or more alkali metal hydroxide.

In a statement 71, the invention provides the precursor composition of statement 70, wherein the alkali metal hydroxide comprises KOH.

In a statement 72, the invention provides the precursor composition of statement 70 or 71, wherein the alkali metal hydroxide is provided in a concentration between 1 to 10 M.

In a statement 73, the invention provides the precursor composition of any one of statements 70 to 72, wherein the alkali metal hydroxide is selected and provided in a concentration to act as an electrolyte for the electroreduction.

In a statement 74, the invention provides a method of reactivating an electrocatalyst that has operated under electroreduction conditions, comprising:
adding a precursor composition to the catholyte, the precursor composition comprising metal ions or a metal salt to form the metal ions, a complexing agent for stabilizing the metal ions dissolved in the catholyte, thereby forming a reactivation catholyte;
applying a constant potential or current to the electrocatalyst in the presence of CO₂ and/or CO under electroreduction conditions to cause electrodeposition of at least a portion of the metal ions onto the electrocatalyst to form a catalytic metal thereon.

In a statement 75, the invention provides the method of statement 74, wherein the CO₂ is provided at least as a CO₂-containing gas flowing through the catholyte solution.

In a statement 76, the invention provides the method of statement 75, wherein the CO₂-containing gas is provided at a flow rate ranging from about 10 standard cubic centimeters per minute to about 1000 standard cubic centimeters per minute during the in-situ electrodeposition, with preference ranging from about 30 standard cubic centimeters per minute to about 100 standard cubic centimeters per minute.

In a statement 77, the invention provides the method of statement 76, wherein the CO₂-containing gas is a CO₂ gas.

In a statement 78, the invention provides the method of any one of statements 74 to 77, wherein constant current is provided for the electrodeposition.

In a statement 79, the invention provides the method of statement 78, wherein the constant current is between −0.01 and −10 A cm⁻².

In a statement 80, the invention provides the method of any one of statements 74 to 77, wherein constant potential for the electrodeposition.

In a statement 81, the invention provides the method of statement 80, wherein the constant potential is between from −0.2 and −3 V versus RHE.

In a statement 82, the invention provides the method of any one of statements 74 to 81, wherein the electrodeposition for reactivation is performed for about 10 seconds to about 600 seconds.

In a statement 83, the invention provides the method of any one of statements 74 to 82, wherein the electrodeposition for reactivation is performed for at least 10 seconds, at least 20 seconds, at least 40 seconds, or at least 60 seconds.

In a statement 84, the invention provides the method of any one of statements 74 to 83, wherein the catholyte is in a cathodic chamber; an anolyte is in an anodic chamber separated from the cathodic chamber via a separator; electrodes are in the cathodic and anodic chambers respectively; and the CO₂ is fed into the cathodic chamber during the electrodeposition for reactivation.

In a statement 85, the invention provides the method of statement 84, wherein the anolyte is provided with the same amount of alkali metal hydroxides as the catholyte.

In a statement 86, the invention provides the method of statement 84 or 85, wherein the electrode in the anodic chamber comprises a material selected from one or more of Ni, Pt and/or Au.

In a statement 87, the invention provides the method of any one of statements 84 to 86, wherein the separator comprises an anion-exchange membrane.

In a statement 88, the invention provides the method of any one of statements 84 to 86, wherein the separator comprises a Nafion membrane.

In a statement 89, the invention provides the method of any one of statements 74 to 88, wherein the metal ions are Cu²⁺ cations.

In a statement 90, the invention provides the method of any one of statements 74 to 89, wherein the precursor composition of any one of statements 60 to 73 is added to or used as the catholyte.

In a statement 91, the invention provides the method of any one of statements 74 to 90, further comprising preparing a precursor mixture, directly adding the precursor mixture to the catholyte, operating under electroreduction conditions to produce C2+ hydrocarbons while reactivating the electrocatalyst.

Techniques described herein relate to enhanced catalyst materials and methods of synthesizing catalysts. For example, methods for synthesizing CO₂ electroreduction catalysts for highly efficient electrosynthesis are described. In one example, in situ electrodeposition of copper (Cu) in the presence of CO₂ gas can preferentially exposes C₂₊ active and selective sites on the Cu catalyst which has increased Cu(100) facets. Such Cu-based catalyst systems can be used for electroreduction of CO₂ to produce C2+ hydrocarbons, such as ethylene. In another example, in situ electrodeposition of silver (Ag) in the presence of CO₂ gas resulted in an Ag catalyst with an increase in the area of Ag(110) facets. Such Ag-based catalysts can facilitate electroreduction of CO₂ to produce CO. Electrodeposition of a catalyst metal in the presence of CO₂ gas can thus facilitate the production of a metal catalyst having a desirable type of exposed facets. In another example, the in situ electrodeposition of Cu is performed in the presence of CO gas, as CORR and CO₂RR have similar mechanisms. The in situ electrodeposition of Cu could also be performed in the presence of a mixture of CO₂ and CO.

A new materials processing strategy in catalyst synthesis was developed. In the in situ electrodeposition Cu under CO₂ gas flow, capping of facets during Cu catalyst synthesis and a two-fold increase in the ratio of Cu(100) facets to other facets was observed. High Faradaic and half-cell power conversion efficiency for C2+ products of 90% and 61% were achieved with such Cu catalysts. These selectivities were achieved at a C₂₊ partial current density of 200 mA cm⁻². Applying the electrodeposition technique to another catalytic metal, it was found that Ag catalysts could also be formed with a 1.5-fold increase in the area of Ag(110) facets. Using such Ag-based catalysts, CO was produced by CO₂ electroreduction with a Faradaic efficiency of 83% and half-cell CO power conversion efficiency of 54% at 260 mA cm⁻². The results of the present study demonstrate a wide application of the new catalyst materials processing strategy for producing catalytic materials.

Other processing techniques (e.g., solution-processed Cu single-crystal nanocubes reporting to have a high exposure of Cu(100) facet; shaped-controlled Cu₂O-derived Cu also reporting to control the Cu(100) exposure) have been reported. However, such techniques have drawbacks. Capping agents have been required to stabilize the unstable Cu(100) nanocubes, which decreases the catalytic activity; the Cu(100) facets fully covered by capping agents are rarely exposed to catalyze CO₂ reduction reaction. Shaped-controlled Cu₂O-derived Cu has needed either capping agents or multiple cyclovoltammetries to synthesize the Cu₂O nanocubes, but the performance of those materials is far from application requirements.

Various implementations of the synthesis methods disclosed herein overcome disadvantages of other techniques, using the CO₂ electroreduction as the capping agents. The adsorption strength of CO₂*, COOH*, CO*, and H*, were determined and it was found that the intermediates favour Cu(100) in their adsorption energy. With the adsorption of these four intermediates, Cu crystals exhibit an evident increase of the Cu(100) proportion relative to Cu without intermediates. As a result, a high Faradaic and half-cell power conversion efficiency for C₂₊ products of 90% and 61% were achieved at a C₂₊ partial current density of 200 mA cm⁻², for example.

In some implementations, the method of synthesizing a catalytic metal includes the in situ electrodeposition of the method (e.g., Cu, Ag, etc.) under CO₂ electroreduction conditions. The method can include the use of an alkaline solution containing metal salts (e.g., Cu salts) and complexing agents as the deposition bath. An increase in the ratio of desirable facets (e.g., Cu(100), Ag(110)) compared to other facets can be achieved. The capping of facets can occur during the catalyst synthesis by in situ electrodeposition under CO₂ electroreduction conditions.

The synthesis techniques described herein can offer a picture in which the intermediates function in analogy with capping agents, regulating the growth of catalysts to produce a highly active catalyst with a high proportion of Cu(100), for example. This results in highly selective CO₂ electroreduction to C₂₊ products and faster kinetics of the overall reaction on CO₂RR-processed Cu catalysts. Specifically, the work obtained a Faradaic efficiency for total C₂₊ products and ethylene of ˜90% and 71%, respectively.

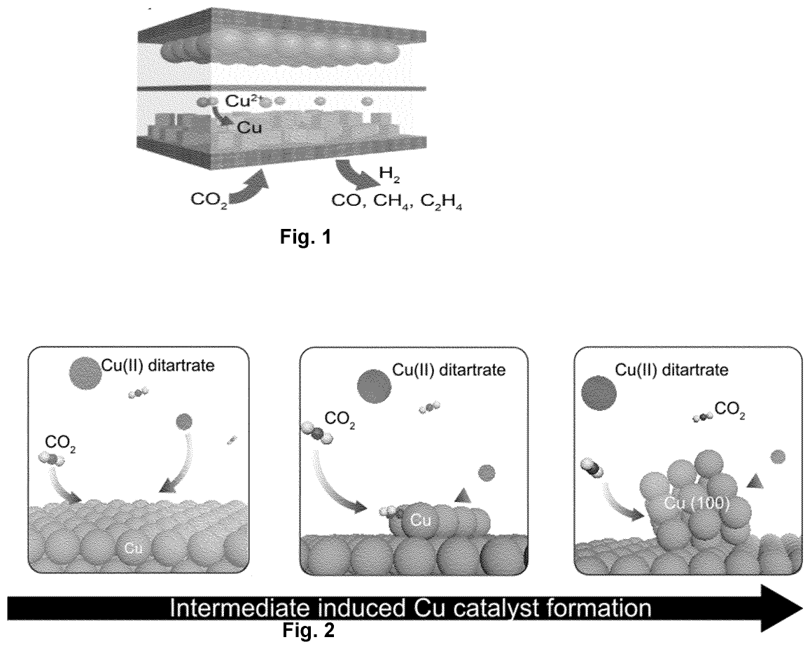

Referring now to FIGS. 1 and 2, the catalyst can be prepared through an electrodeposition approach that is schematically illustrated in the figures. In general, the deposition aqueous solution can include copper (II) salt (e.g., one or more of copper sulfate, acetate, nitrate, halides, acetylacetonate, perchlorate, hydroxide, carbonate basic, tartrate hydrate, etc.); one or more complexing agents (e.g., ammonia, ethylenediamine, tartrate acid and salts, citric acid and salts, ethylenediaminetetraacetic acid and salts, etc.); and alkali metal hydroxides.

A seed layer (e.g., 5-10 nm) of Cu nanoparticles can first be deposited on a gas diffusion layer (GDL) using thermo-evaporation, e-beam evaporation, atomic layer deposition, or magnetron sputtering, for example. The gas diffusion layer with the Cu seed layer can then be fixed in a cathodic compartment of a gas-flow electrolyzer. The deposition solution is used as the catholyte, and a solution containing alkali metal hydroxides is used as the anolyte (e.g., the anolyte can include the same amount of alkali metal hydroxides as the catholyte). The counter electrode can be composed of various materials, such as any one of Ni, Pt, Au, etc., or a combination of materials. The gas-flow electrolyzer can include a separator between the cathodic and anodic compartments, and the separator may be an anion-exchange or Nafion membrane.

CO₂ gas is provided in the cathodic compartment, and may be done so in various ways. For example, a gas flow of CO₂ may be provided. The CO₂ gas flow can be about 10 to about 1000 standard cubic centimeters per minute, for example. The catalyst can be electrodeposited on the GDL using a constant current or constant potential. For example, the constant current can range from about −0.01 to about −10 A cm⁻². The constant potential can range from about −0.2 to about −3 V versus RHE. The current/potential can be applied for about 10 seconds to 600 seconds. FIGS. 1 and 2 generally illustrate the forming of Cu(100) facets by such an electrodeposition method.

In addition, examples of the electrocatalyst described herein can be used as a catalyst layer in a composite multilayered electrocatalyst (CME) that includes a polymer-based gas-diffusion layer, a current collection structure, and the catalyst layer, sandwiched in between. The current collection structure can include a carbon nanoparticle layer applied against the catalyst layer, and a graphite layer applied against the nanoparticle layer. In one possible implementation of the CME, it includes a hydrophobic polymer-based support such as polytetrafluoroethylene (PTFE); a Cu—Al or other multi-metal catalyst material deposited on top; a layer of carbon-based nanoparticles (NPs) atop the catalyst; and an ensuing layer of graphite as the electron conductive layer. In this configuration, the PTFE layer, which can be substantially pure PTFE or similar polymer, acts as a more stable hydrophobic gas-diffusion layer that prevents flooding from the catalyst; carbon NPs and graphite stabilize the metal catalyst surface; the graphite layer both serves as an overall support and current collector. In an alternative implementation, the CME includes a hydrophobic polymer-based layer; the multi-metal electrocatalyst deposited on top; and then a layer of conductive material such as graphite deposited on top of the catalyst layer. In this configuration, the stabilization material (e.g., carbon nanoparticles) are not present as a distinct layer in between the graphite and the catalyst layers. Other features of the CME and related CO₂RR methods as described in U.S. 62/648067 can be used in combination with the electrocatalyst and methods described herein.

Furthermore, examples of the electrocatalyst described herein could be used in combination with boron (B) doping or Cu-Al catalysts that include both Al and Cu metals, respectively described in 62/661,723 and 62/701,980, which are both incorporated herein by reference.

It is also noted that the use of a precursor composition can enhance performance in CO₂ electroreduction operations. For example, this work facilitated improving the CO₂RR stability at 350 mA cm⁻² by adding precursor to the electrolyte. Stability at high current densities is typically challenging in CO2RR, especially for Cu catalysts. Although wet chemistry can make Cu nanocubes which have 100% Cu(100), Cu catalysts lose this feature under operating condition due to the reconstruction of catalysts. In addition, the reconstruction becomes more serious when current density increases. Furthermore, high current densities would generate more product bubbles, which could partially disconnect Cu sites. In this case, Cu would be dissolved in KOH, meaning that the amount of active materials decreases. Thus, irrespective of the type of Cu that is initially used, it has been observed that it is eventually deactivated, especially at high current densities. However, in the present work, the in-situ processing provides a good surface Cu(100) exposure, as shown in the material characterizations (SEM, TEM, OH− adsorption, operando XAS), and moreover this approach allows producing fresh and highly active catalyst in real time during CO2RR operation. For example, a precursor mixture can be added to the electrolyte in batch or continuously so that reactivation of the catalyst metal can be achieved under CO₂ electroreduction conditions to reform Cu(100) exposed facets. The precursor mixture can be formulated depending on the initial composition of the electrolyte in order to obtain a desired overall composition once combined. The precursor mixture includes at least metal ions (from a metal salt) and a complexing agent all within an aqueous medium. The precursor mixture can also include KOH at a different concentration compared to the electrolyte into which it is added. Once added, the electrolyte can be subjected to electroreduction conditions in the presence of CO₂ for reactivation of the catalytic metal on the electrolyte, and those electroreduction conditions can be provided for a reactivation period followed by the process returning to the normal electroreduction conditions for producing the desired hydrocarbon products.

It will be appreciated from the overall description and the experimentation section in particular that the catalyst materials as well as the associated methods described herein can have a number of optional features, variations, and applications.

### EXAMPLES & EXPERIMENTATION

Electrochemical carbon dioxide (CO₂) reduction upgrades CO₂ to value-added renewable fuels and feedstocks. The selective electrosynthesis of C₂₊ hydrocarbons and oxygenates has attracted recent attention in light of the high market price they command per unit energy input. Today's actual selectivities toward C₂₊ products curtail system energy efficiency, and hence limit the potential for economically competitive renewable fuels and feedstocks. Cu(100) is known to be the most active facet for producing C₂₊ products; however, the predominant exposure is of catalysis-unfavourable facets, limiting activity and selectivity toward desired products. The present study presents a new materials processing strategy in catalyst synthesis—the in situ electrodeposition of copper (Cu) under CO₂ gas flow—that preferentially exposes C₂₊-active and -selective sites on the Cu catalyst. The present study observes capping of facets during Cu catalyst synthesis, with evidence of facet-specific control over facet development obtained using in-situ Raman and operando hard X-ray adsorption spectroscopy. As a result, the study finds a two-fold increase in the ratio of Cu(100) facets to other facets, quantitated using OH⁻ electroadsorption. The study reports as a result a record-high Faradaic efficiency for C₂₊ products of 90%. This work achieved these selectivities at an C₂₊ partial current density of 200 mA cm⁻². The study reports the highest half-cell C₂₊ power conversion efficiency of 61%. To explore the general nature of the concept, the study applied it also to Ag catalysts, and achieved a 1.5-fold increase in the area of Ag(110) facets. The work used such Ag catalysts to produce CO with a Faradaic efficiency of 83% and half-cell CO power conversion efficiency of 54% at 260 mA cm⁻², demonstrating the wider application of the new catalyst materials processing strategy.

The utilization of CO₂ is a key step to close the anthropogenic carbon cycle, and electrochemical reduction is one of the most promising strategies to fulfill this goal by converting CO₂ to fuels and value-added feedstocks using renewable electricity. Among products, C₂₊ hydrocarbons and oxygenates—such as ethylene (C₂H₄), ethanol (EtOH) and n-propanol (n-PrOH)—are attractive relative to their C₁ counterparts (e.g., carbon monoxide (CO) and formic acid) in view of their major roles in chemical industry. However, catalyzing the formation of these multi-carbon compounds via the CO₂ reduction reaction (CO₂RR) with high selectivity is extremely challenging. The multistep reaction, and multiple competing pathways, complicate the design of catalysts for a single desired C₂ product.

To date, Cu-based materials have most selectively and efficiently electrocatalyzed the conversion of CO₂ to C2₊ hydrocarbons and oxygenates. Further tailoring, using materials chemistry, the Cu surface to tailor electron transfer in each reaction step, and narrow thereby the product distribution, has the potential to improve selectivity toward desired multi-carbon products.

Electrochemical derivation of high oxidation-state Cu species offers one avenue to realize selective and active C₂₊ product formation. However, the Faradaic efficiency for C₂₊ products has, until now, remained 80%. This study sought further means to tune the exposed active sites in a polycrystalline Cu catalyst to enhance the selectivity towards C₂₊ products.

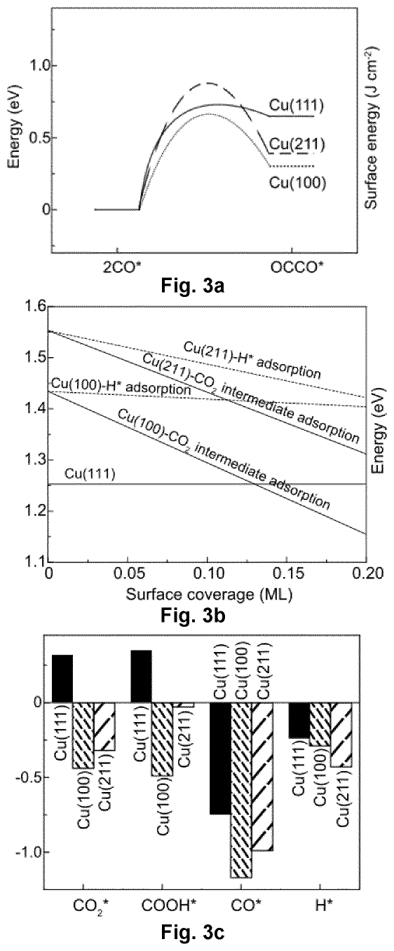

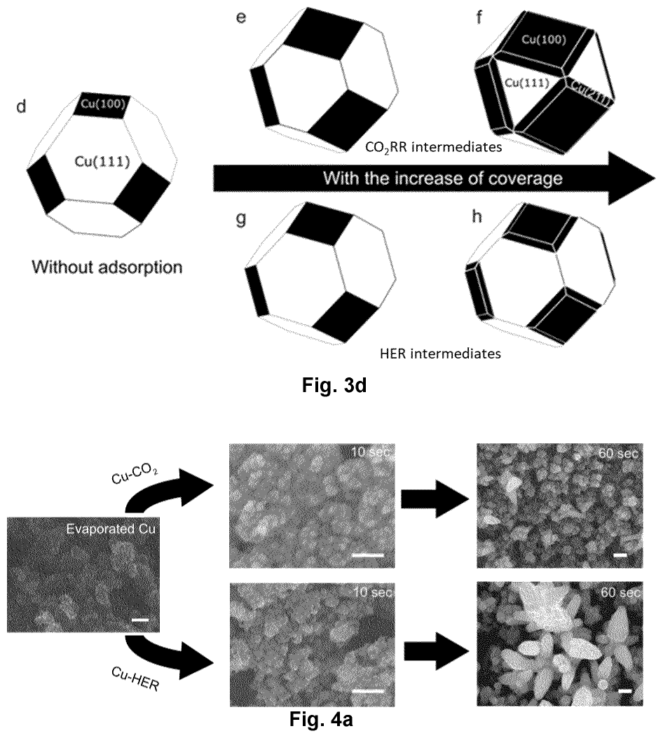

Cu(100) has been well studied as the most active facet for CO dimerization, the key elementary step for producing C₂₊ products. On Cu(100), the activation energy and enthalpy change of CO dimerization are 0.66 eV and 0.30 eV, respectively, which are lower than in the case of either Cu(111) or Cu(211) (see FIG. 3a, and Table 1).

It was reasoned that introducing a maximum of Cu(100) active facets at the surface of a polycrystalline Cu catalyst could boost its activity and selectivity toward C₂₊ products. The study developed therefore a new materials processing method that would regulate Cu facet exposure on the catalyst surface.

### Results

Density Function Theory (DFT) calculations. The study first investigated the stability of the facets of Cu with low Miller indices by calculating the surface energies using DFT. The most stable facet in polycrytalline Cu is Cu(111) according to the calculated surface energies: 1.25 J cm⁻² for Cu(111), 1.43 J cm⁻² for Cu(100), and 1.55 J cm⁻² for Cu(211) (FIG. 1b and Supplementary Table 2). Stabilizing the less-favoured Cu(100) during the formation of polycrytalline Cu catalysts thus requires a kinetic strategy during materials synthesis.

In the growth of Cu single crystals, capping agents are employed to stabilize specific facets. The study hypothesized that, under CO₂RR, the intermediates along reductive pathways could also shape the formation of different facets along the same principle, where the adsorption strength of the intermediates plays a role analogous to that of capping agents.

The study calculated the adsorption strength of CO₂*, COOH*, CO*, and H* (Table 3) and found that the CO₂RR intermediates favour Cu(100) in their adsorption energy, while the adsorption of H*—the intermediate related with hydrogen evolution—is strongest on Cu(211) (FIG. 3c). Then, the study modeled the equilibrium shapes of a Cu crystal using the Wulff construction. With the adsorption of these four intermediates, Cu crystals exhibit an evident increase of the Cu(100) proportion relative to Cu without intermediates (FIGS. 3e and 3f), while no clear changes of Cu(100) concentration are found for the HER intermediates (FIGS. 3g and 3h). These findings lead to the exploration of synthesizing the catalyst in the presence of CO₂RR intermediates.

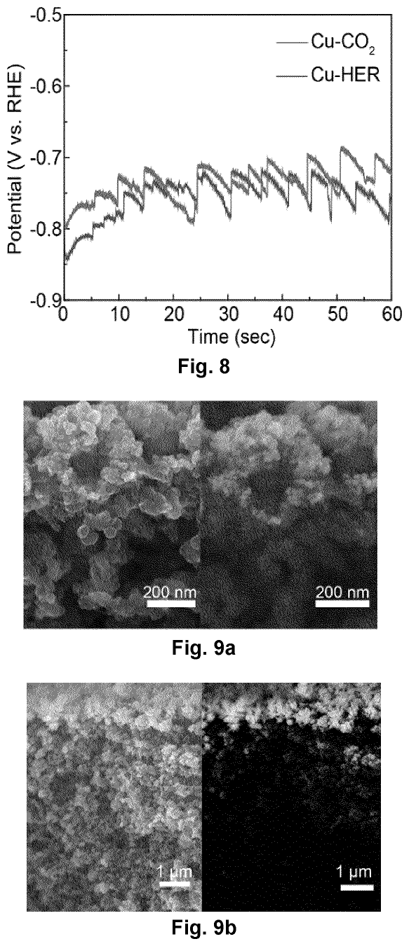

Intermediate adsorption engineers the Cu facets. Experimentally, the study electrodeposited catalyst on gas diffusion layers (GDL) in a CO₂-flow electrolyser (FIG. 8). Tartrate anions were added as complexing agents to stabilize the catalyst precursor, Cu²⁺, in alkaline conditions. When the study applied a cathodic current (400 mA cm⁻²), the Cu(II) ditartrate anions were reduced to Cu metal on the GDL, accompanied by CO₂ electroreduction on the Cu surface.

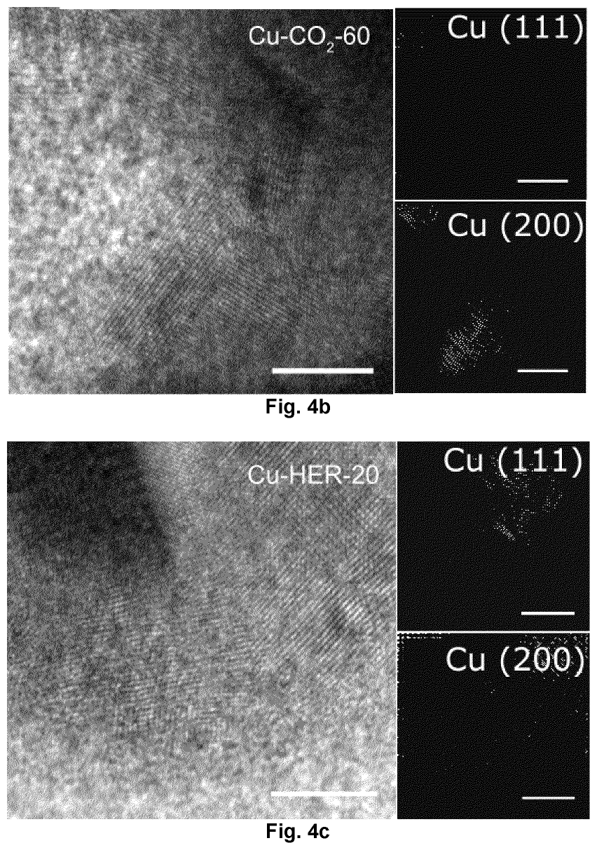

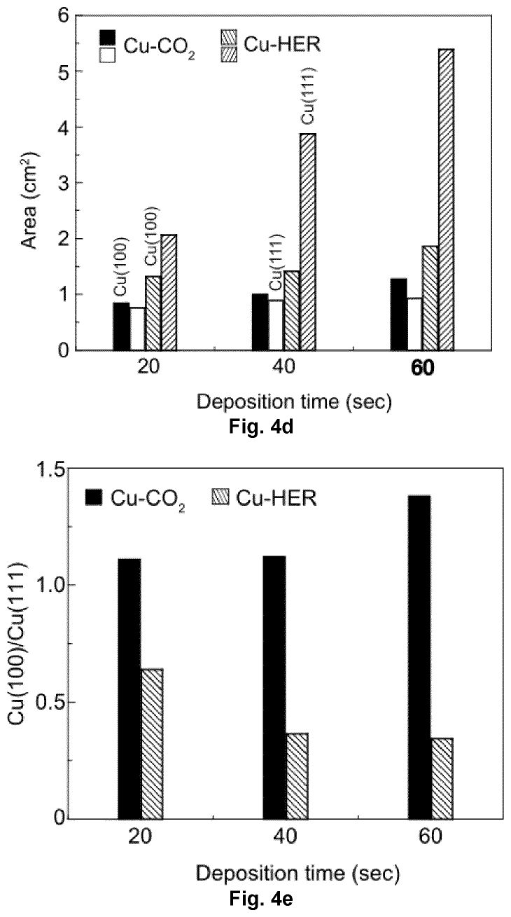

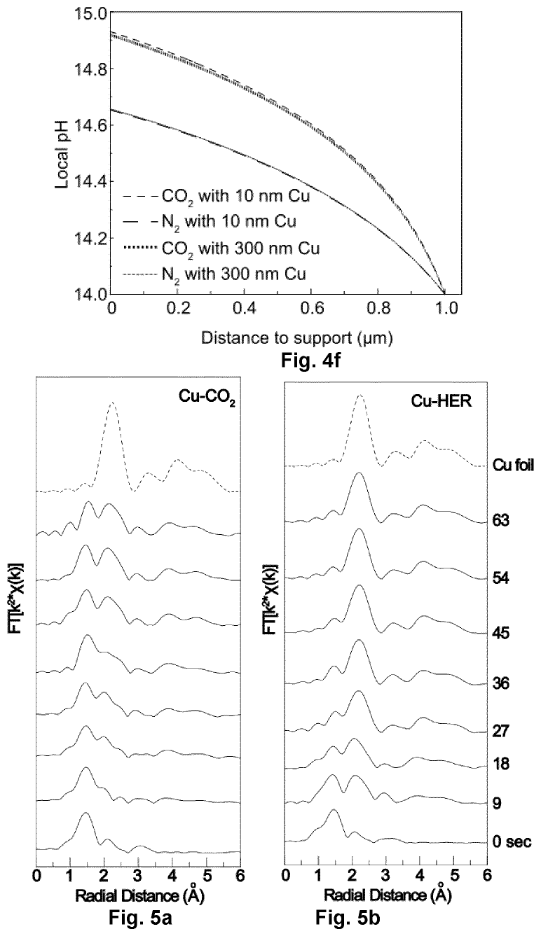

To gain insight into the growth of Cu catalysts during the electrodeposition, the study investigated the time-dependent structural evolution of the Cu over the course of catalyst formation (FIG. 4a). The starting evaporated Cu seed layer exhibited a nanoparticle morphology with a size of ˜10 nm (the left scanning electron microscope, SEM, image). After 10 seconds of electrodeposition under CO₂ gas flow, Cu with a particle size of ˜20 nm formed (labelled named as Cu—CO₂ in FIG. 4a). Cross-section secondary electron and backscattered electron (BSE) images confirmed a ˜200 nm thickness of this Cu layer (FIG. 9a). Extending the deposition time to 60 sec increased the crystal size to ˜50 nm, with dendritic structures forming simultaneously. The thickness of the 60 sec Cu catalyst layer is ˜600 nm (FIG. 9b).

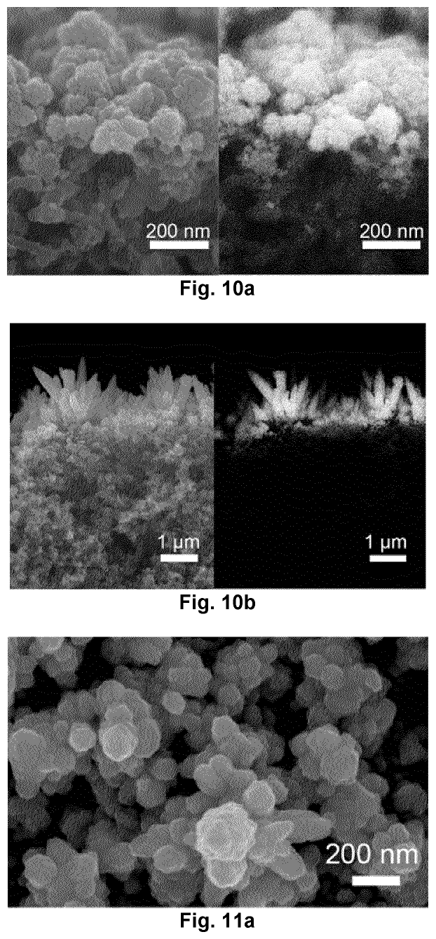

To challenge the idea that CO₂ played a role during catalyst synthesis, the study grew control catalysts whose synthesis was accompanied by H₂ evolution only (labelled Cu-HER) by replacing CO₂ with N₂ gas at the same flow rate. The Cu catalyst layer formed in 10 seconds under N₂ gas exhibited a particle size ˜20 nm with a ˜300 nm thickness (FIG. 10a). After 20 seconds, the study observed an aggregate size of ˜100 nm, with larger dendrites formed (FIG. 11a), and the catalyst layer exhibited a thickness of ˜500 nm, similar to the thickness of Cu—CO₂ formed in 60 seconds (FIG. 11b). After 60 sec, the Cu-HER crystals were predominantly in the form of dendritic structures (FIG. 4b, purple arrows, the right image) with a length ranging from 0.5 to 2 μm (FIG. 10b).

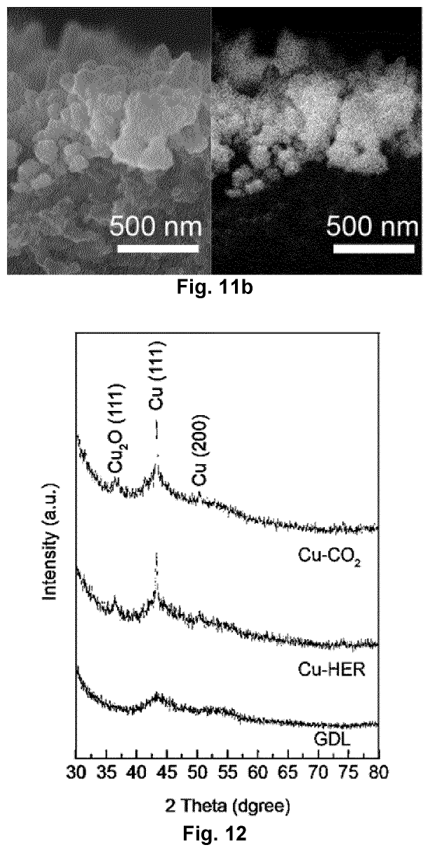

For both Cu—CO₂ and Cu-HER catalysts, the polycrystalline nature of each was also in evidence when analyzed using grazing-incidence wide-angle X-ray Scattering (GIWAX), X-ray diffraction (XRD) (FIG. 12), and high-resolution transmission electron microscopy (HRTEM, FIGS. 4b and 4c). The co-existence of Cu(111) and Cu(100) can be observed on both Cu—CO₂ and Cu-HER.

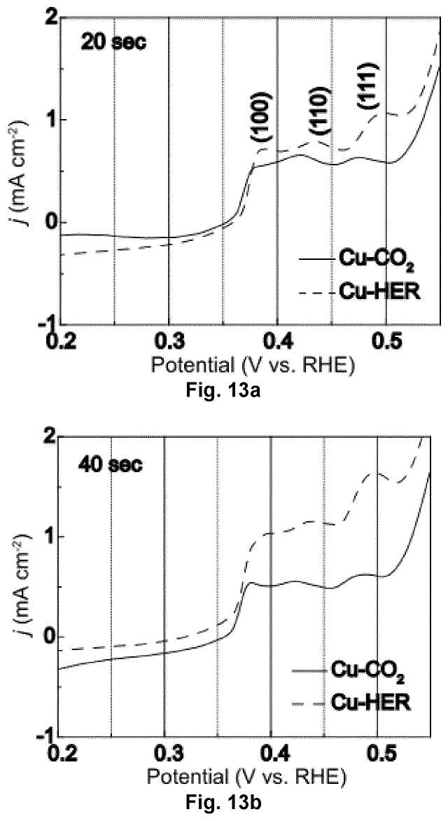

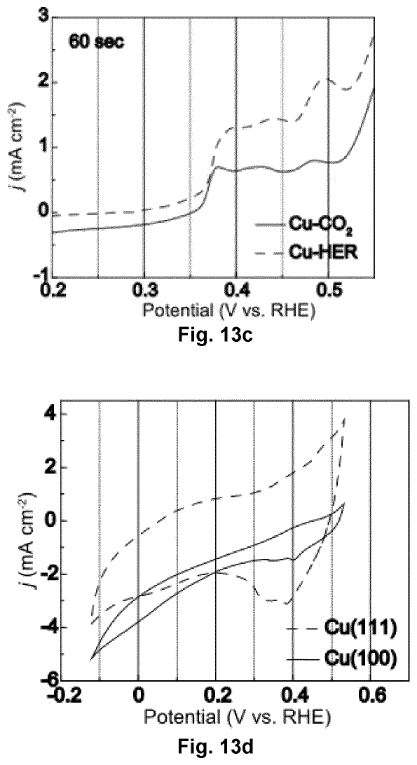

Since each Cu facet features its own distinct OH⁻ electrochemical adsorption behavior, the study sought to quantify Cu(100) exposure using the OH⁻ electroadsorption technique (FIG. 13). Linear sweep voltammetry profiles reveal electrochemical OH⁻ adsorption peaks on Cu(100), (110) and (111) at the potential of ˜0.37, 0.43, 0.48 V vs. RHE, respectively. Using these peaks, the surface area of each facet (see Method) for Cu catalysts deposited for different deposition (FIG. 4d, e) was calculated. The growth of Cu(111) is significantly suppressed in the sample made under CO₂RR (Cu—CO₂-60), with a (111) surface area of less than 0.9 cm² per 1 geometric cm² electrode (FIG. 4d). The Cu(100)-to-Cu(111) surface area ratio of Cu—CO₂ is >1.7 times that in the case of Cu-HER (FIG. 4e). From reaction-diffusion modeling, it was estimated that the local pH for Cu—CO₂ and Cu-HER are ˜14.9 and 14.7 (FIG. 4f), which argues against a significant differential impact of local OH⁻ on the catalyst surface structure.

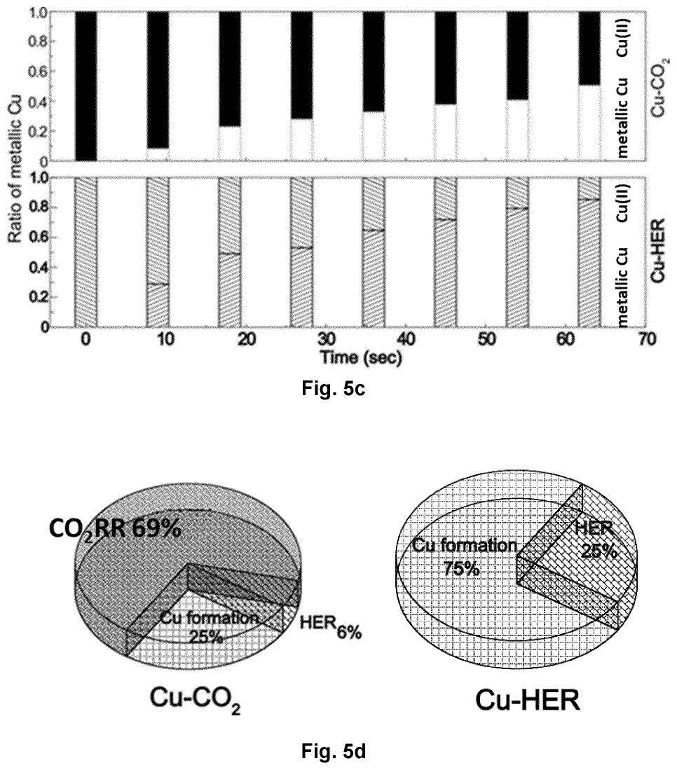

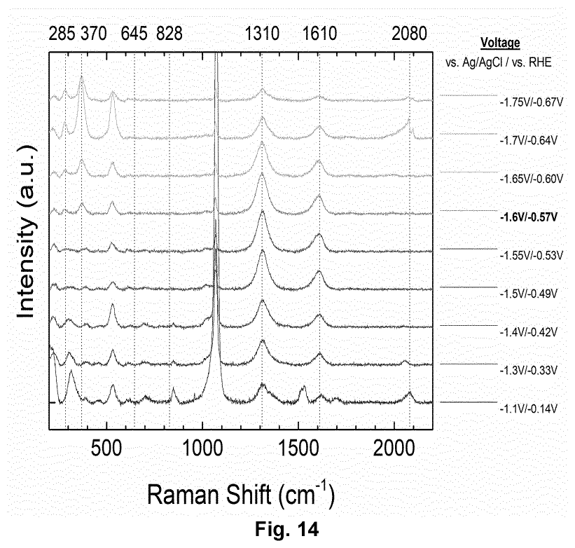

For real-time monitoring of catalyst formation, the study performed a series of in-situ/operando studies. The study obtained operando Raman spectra to study chemisorbed intermediates when CO₂ was present (FIG. 14). Peaks located at 285 and 370 cm⁻¹ are ascribed to the Cu—CO bond. The study utilized operando hard X-ray absorption spectroscopy (hXAS) to track the electrochemical formation of Cu with time resolution. The starting spectrum exhibits a Cu²⁺ complex feature ascribed to the Cu(II) ditartrate ions in the electrolyte. For both catalysts, metallic Cu emerges once a constant 400 mA cm⁻² current (FIGS. 5a and 5b) is applied. The ratio of metallic Cu and Cu(II) ditartrate for Cu—CO₂ reaches roughly 50:50 after 60 seconds (FIG. 5c, upper panel). However, for Cu-HER, a similar ratio of ˜53:47 is obtained at 27 sec, and it further increases to ˜88:12 after 60 sec (FIG. 5c, lower panel). This can lead to the conclusion that synthesis under CO₂RR reduced the amount of Cu deposited on the GDL for the Cu—CO₂ catalyst compared to Cu-HER deposited following similar times (FIG. 5d).

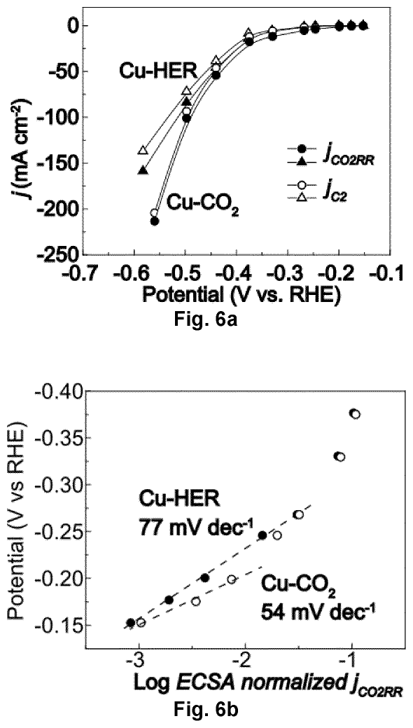

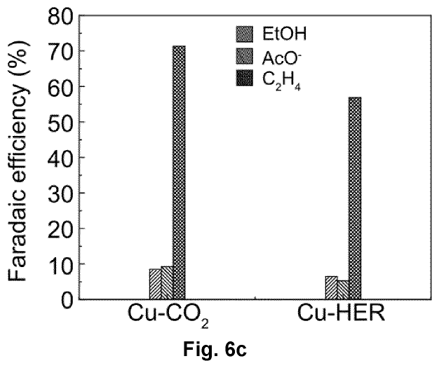

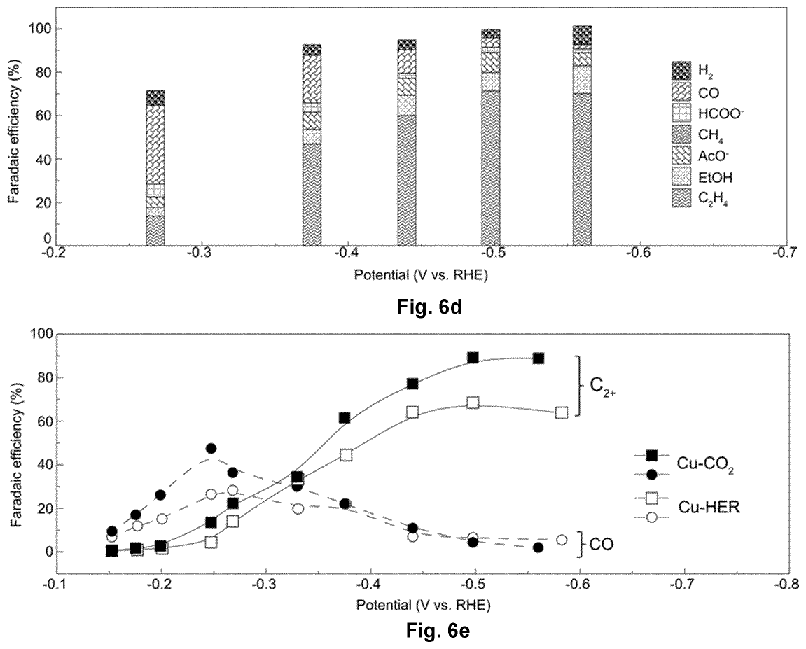

CO₂ electroreduction performance. The catalytic performance of Cu—CO₂ catalysts was evaluated in 10 M KOH electrolyte, conditions in which the energy barrier of CO-CO dimerization is significantly reduced. As shown in FIG. 6a, the partial CO₂RR current density on Cu—CO₂ at the potential of −0.38, −0.44, −0.5 and −0.56 V vs. RHE is ˜18, 55, 100 and 210 mA cm⁻², respectively. The total CO₂RR Faradaic efficiency increases to over 90% after the potential reaches −0.5 V vs. RHE (Table 4). While on Cu-HER, the maximum Faradaic efficiency for total CO₂RR is limited to 80% with partial current density ˜160 cm⁻² (Table 5).

The CO₂RR Tafel slope is 54 mV dec⁻¹ on Cu—CO₂ and 77 mV dec⁻¹ on Cu-HER (FIG. 6b). This reduced Tafel slope of Cu—CO₂ indicates the overall reaction is accelerated and controlled by a rate-determining proton transfer step on Cu—CO₂. The study found a ˜10 mV shift in the OH⁻ adsorption peaks towards more negative potentials on Cu—CO₂ (FIG. 13), which serves as a surrogate for strong CO₂* binding. This lead to the conclusion that Cu—CO₂ binds strongly and stabilizes the CO₂* intermediate, and ultimately improves the kinetics of CO₂ activation, CO formation, and subsequent CO-CO coupling.

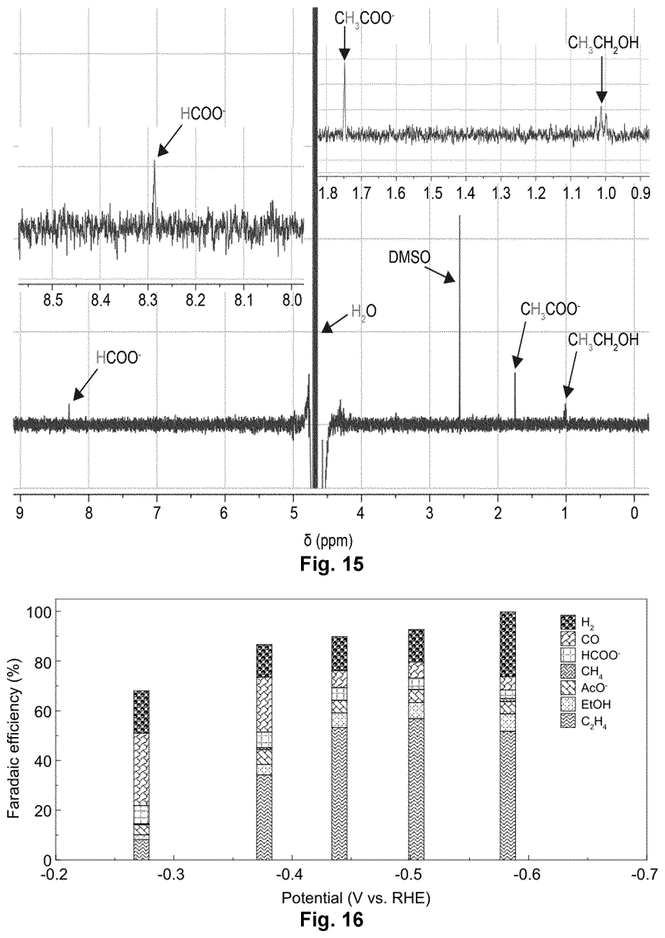

In terms of selectivity, the total CO₂RR Faradaic efficiency is higher than 90% across the range −0.44 to −0.56 V. The C₂₊ onset potential is observed at a low voltage, −0.15 V vs. RHE (Table 4). At a potential of −0.5 V vs. RHE, the C₂₊ product Faradaic efficiency on Cu—CO₂ peaks reaches its peak value of ˜90 ±1% (71±2% for ethylene, 9±1% for ethanol and 9±1% for acetate, FIG. 6c and FIG. 15) with a C₂₊ partial current density of ˜94 mA cm⁻² (FIG. 6a), corresponding to a record 61% half-cell power conversion efficiency (PCE) for C₂₊ products (Table 5). For Cu-HER catalysts, the highest C₂₊ Faradaic efficiency observed is 69±3% (FIG. 6c and FIG. 15). Increasing the potential to −0.56 V on Cu—CO₂ leads to a C₂₊ partial current density of ˜204 mA cm⁻² with a well-retained Faradaic efficiency of ˜89% for C₂₊ products (FIG. 6d). This is equal to a 60% half-cell PCE for C₂₊ products. In contrast, on the Cu-HER catalyst, the C₂₊ partial current density is a notably lower 140 mA cm⁻² at −0.59 V (FIG. 6a), with a Faradaic efficiency of 64% and a half-cell PCE of 40% (FIG. 16). Detailed CO₂RR performance for both Cu—CO₂ and Cu-HER is shown in Tables 4 and 6.

Since only chemisorbed CO can be further converted to hydrocarbons and oxygenates, the study plotted the potential-dependent CO and C₂₊ selectivity trend (FIG. 6e). Cu—CO₂ exhibits a higher CO selectivity peaking at 48±2% and related increasing rate at lower overpotential range (<−0.4 V vs. RHE). The maximum CO Faradaic efficiency on Cu-HER is a notably lower 28±1%. The higher CO production on the Cu—CO₂ catalyst at lower overpotentials agrees with a picture of higher CO* intermediate availability when one moves to higher overpotentials. This agrees with the notably higher efficiency with which Cu—CO₂ converts CO to C₂₊ hydrocarbons and oxygenates.

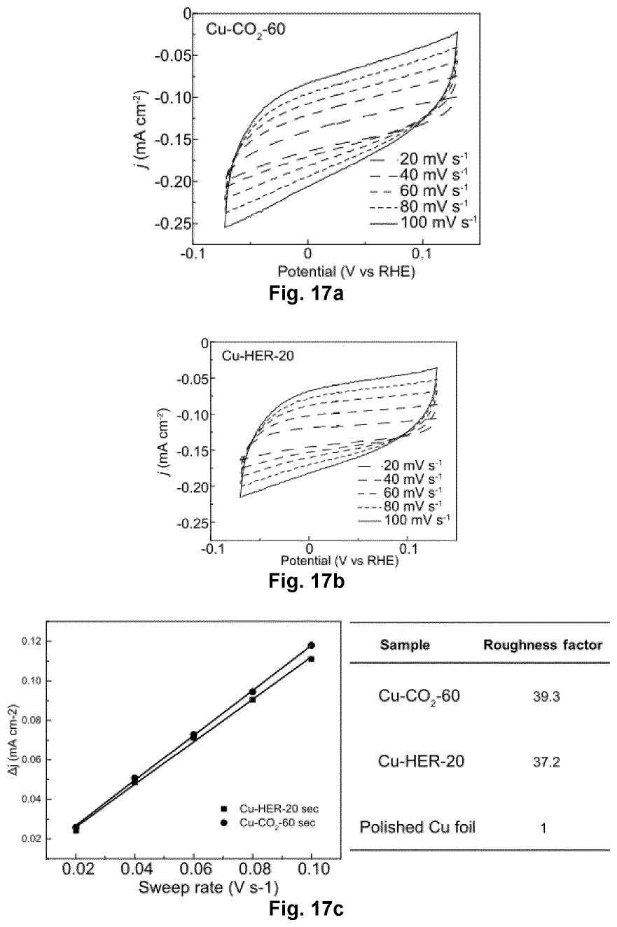

The study also characterized extended-operating-time CO₂RR performance for the catalyst including controls. The study found that the C₂H₄ Faradaic efficiency remained >60% on Cu—CO₂ following 3 h under CO₂RR. The electrochemical active surface area (ECSA), determined by double layer capacitances, exhibits a ˜3% influence on the activity of each catalyst (FIG. 17).

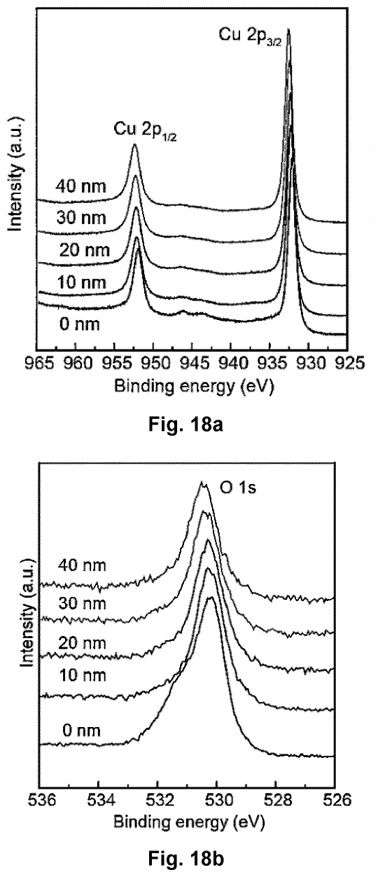

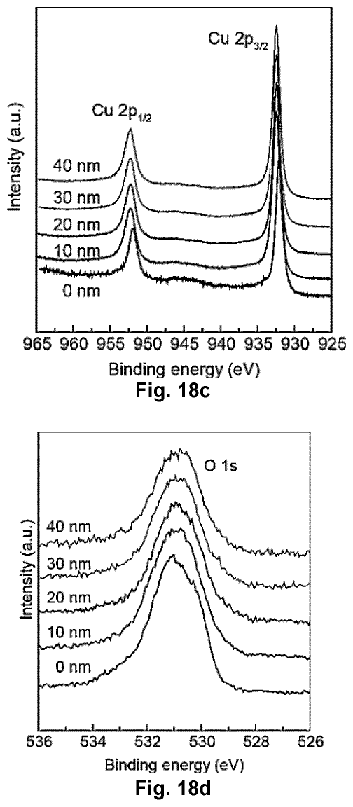

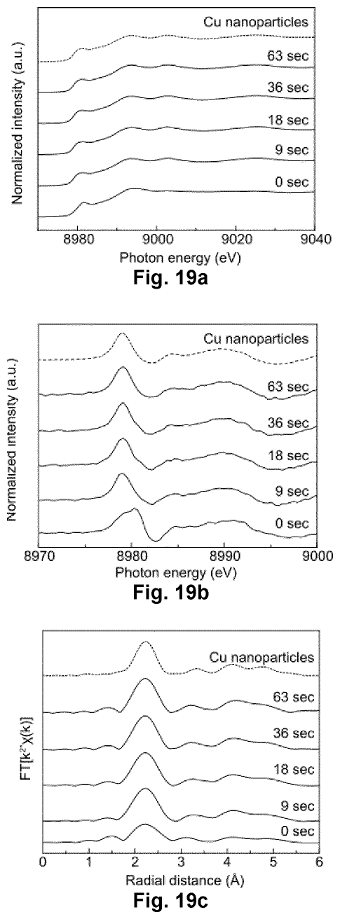

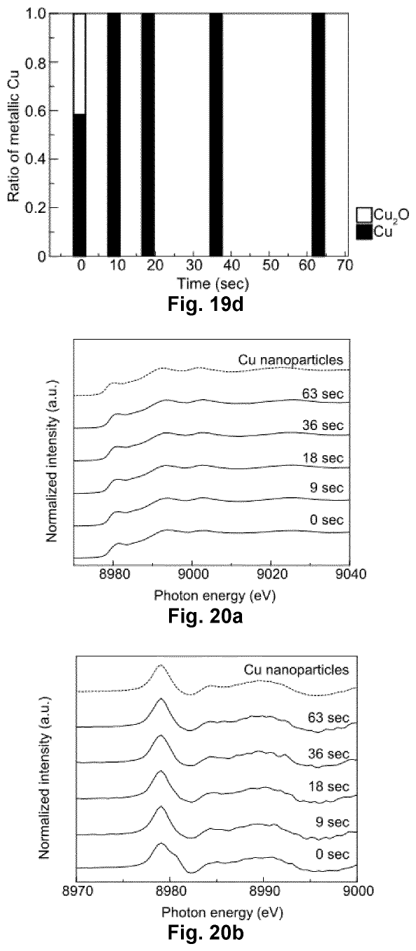

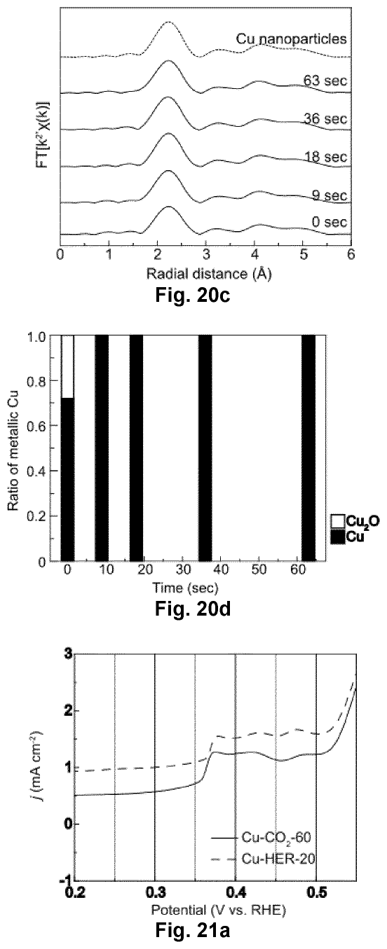

Over the course of CO₂ electroreduction, the Cu₂O feature resulting from post-oxidation (FIG. 18) diminishes quickly once a potential of −0.5 V vs RHE is applied (FIGS. 19 and 20). For both Cu—CO₂ and Cu-HER, a pure metallic Cu feature is revealed by operando hXAS after 9 seconds of CO₂RR operation in 10 M KOH. This indicates that the CO₂RR activity on both catalysts originates from the pure metallic Cu. As a similar coordination number (CN) of ˜11.5 was observed between the two catalysts (Tables 7 and 8), neither the size effect nor the real-time oxidation state of Cu appears to be the dominant determinant of the differences in selectivity and activity.

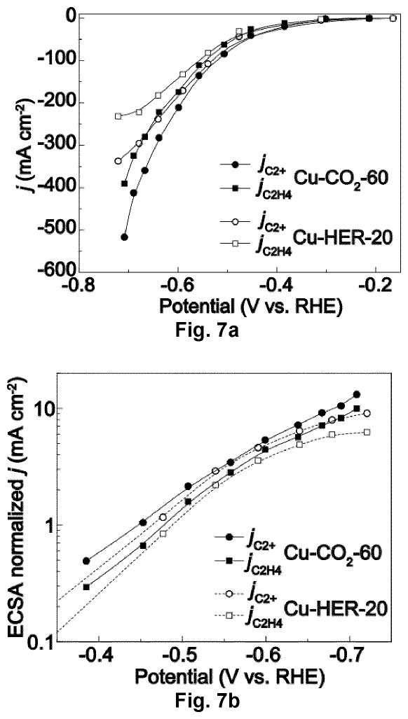

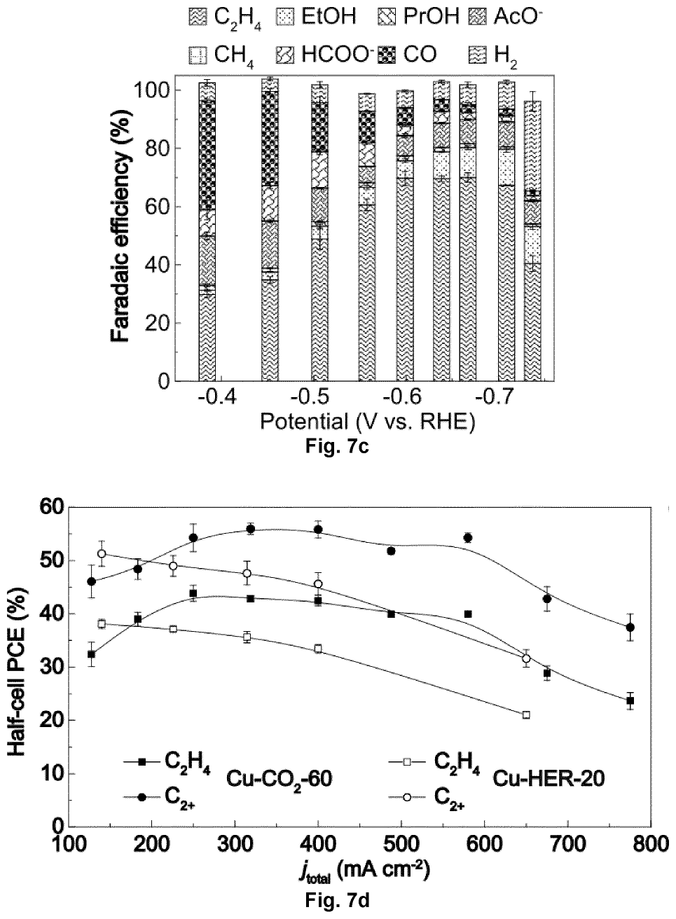

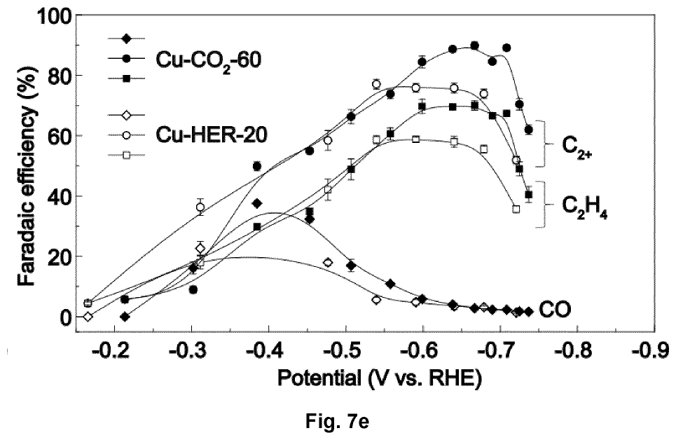

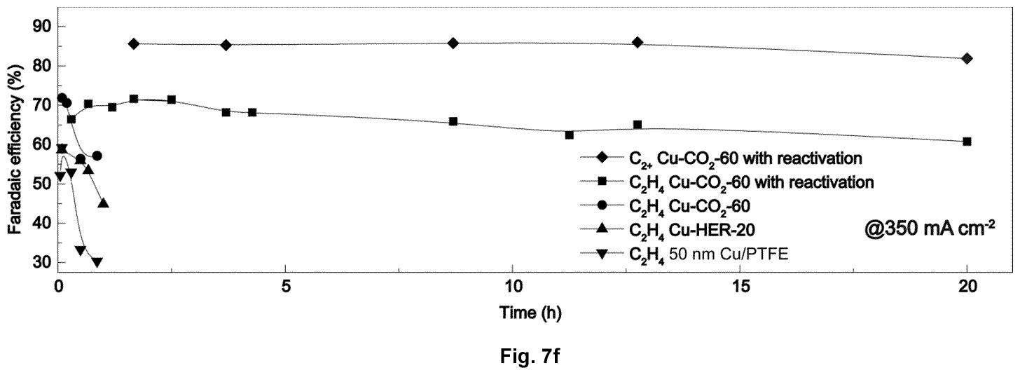

The study then transplanted this in-situ catalyst processing method to a polytetrafluoroethylene (PTFE)-based support. Porous PTFE membrane with 50 nm sputtered Cu was used as the seed layer for catalyst growth. As shown in FIG. 7a, the C₂H₄ and C₂₊ partial current density was boosted to 390 and 520 mA cm⁻². The enhanced activity on Cu—CO₂ (60 sec) catalyst was confirmed by its higher ECSA normalized current density (FIG. 7b). The study achieved ˜70% and 85-90% Faradaic efficiency for C₂H₄ and C₂₊ products from −0.37 to −0.70 V vs RHE in the current range of 250-600 mA cm⁻² in 7 M KOH (FIG. 7 c). The C₂H₄ and C₂+ half-cell power conversion efficiency (PCE) peaks at ˜44% and ˜56% at 250 mA cm⁻², and remains at ˜40% and ˜54% at the current density of 600 mA cm⁻² (FIG. 7d). The Cu—CO₂ (60 sec) catalyst, compared to the Cu-HER (20 sec) control, exhibits an average 10 percentage points increase in term of both C₂H₄ and C₂+ half-cell PCE. The higher CO production on the Cu—CO₂ (60 sec) catalyst at lower overpotentials was also confirmed on PTFE-based supports (FIG. 7e).

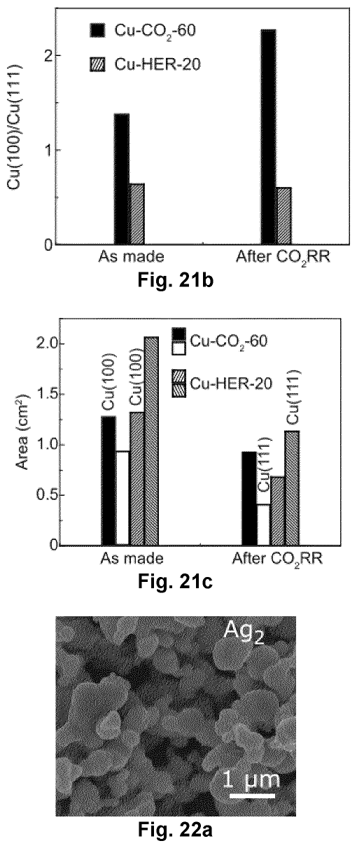

The decrease of absolute area of each facet was observed on Cu—CO₂ (60 sec) catalyst after 1000 sec CO₂RR operation (FIG. 21), which could be attributed to potential corrosion and reconstruction. This indicates a loss of active sites and catalyst deactivation. To improve the stability, 0.8wt % Cu precursor was directly added to the electrolyte, and a constant C₂₊ FE (to within 3% relative) for an initial 20 h operation at 350 mA cm⁻² was achieved as the result (FIG. 7f).

### Discussion

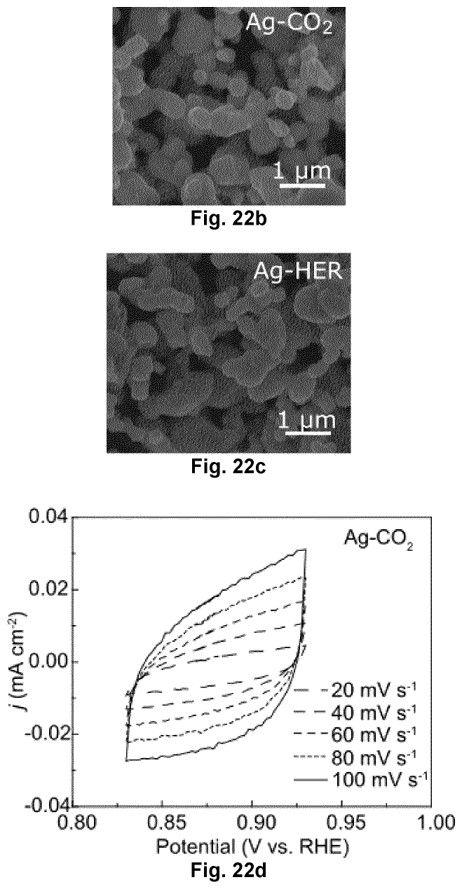

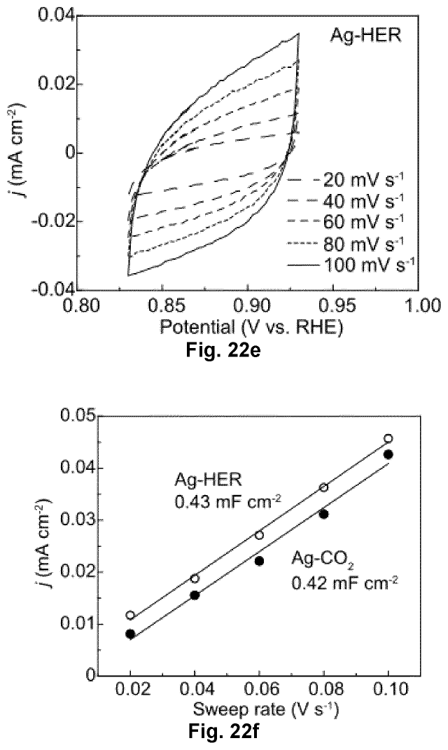

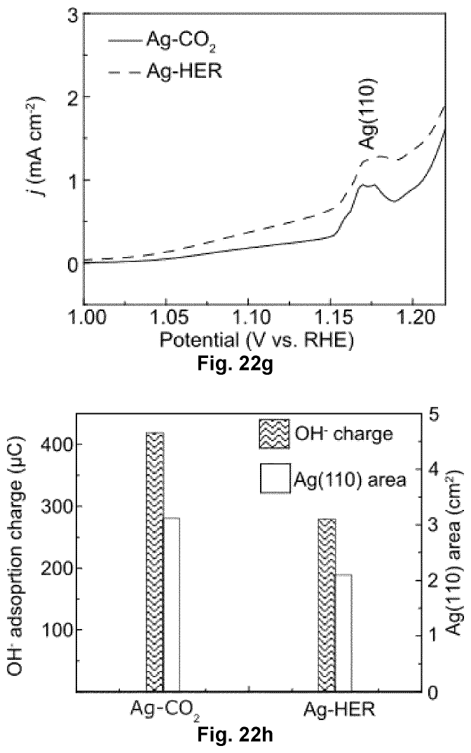

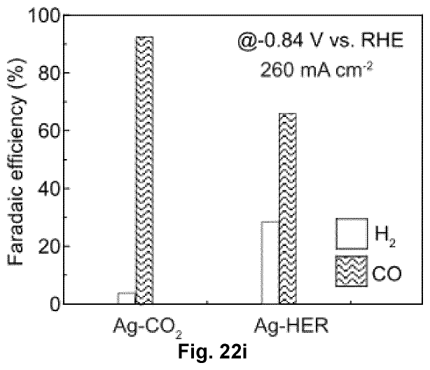

To explore whether CO₂RR-synthesized catalysts can be faceted in more than one materials system, and with analogous benefits to electrosynthesis products beyond ethylene, the study also prepared oxide-derived Ag under CO₂RR conditions and HER conditions (Ag—CO₂ and Ag-HER). The study found that the catalysts exhibit similar particle sizes in the range 0.1 to 1 μm, and similar ECSA (FIGS. 22a-f). The study observed a 1.5-fold increase in the area of Ag(110) facets (˜3 cm²) on Ag—CO₂ (Supplementary FIGS. 22g, 22h), and Ag(110) are the most active for catalyzing CO₂ reduction to CO on Ag. The Faradaic efficiencies for CO and H₂ were 83±2% and 3±1% on Ag—CO₂ at 260 mA cm⁻² and −0.84 V vs. RHE (FIG. 21i). This corresponds to a 54% CO half-cell PCE. This CO selectivity is 1.4 time higher that on Ag-HER (60% Faradaic efficiency), confirming that CO₂RR-synthesized catalyst faceting can be extended and exploited in other systems.

This work presents a catalyst materials synthesis strategy that can utilize CO₂RR intermediate adsorption to tune the exposed Cu catalyst facets. The study offers a picture in which the intermediates function in analogy with capping agents, regulating the growth of catalysts to produce a highly active catalyst with a high proportion of Cu(100). As a result, the work achieves highly selective CO₂ electroreduction to C₂₊ products and faster kinetics of the overall reaction on CO₂RR-processed Cu catalysts. Specifically, the study obtained a Faradaic efficiency for total C₂₊ products and ethylene of ˜90% and 71%, respectively, including at current densities exceeding 200 mA cm⁻² and record half-cell PCE for C₂₊ products of ˜60%. The study demonstrated the wider applicability of this CO₂RR-processed catalyst faceting strategy, increasing (110) facet exposure on Ag catalysts and achieving as a result 83% CO Faradaic efficiency at −0.84 V vs. RHE and half-cell CO PCE of ˜54%. In situ materials processing under catalytic conditions provides an avenue to expose preferentially the active sites needed in reactions, and suggests a principle for designing selective and active catalysts.

### Materials and Methods

Density functional theory calculations. In this work, all the density functional theory (DFT) calculations were carried out with a periodic slab model using the Vienna ab initio simulation program (VASP) (https://www.vasp.at/). Detailed theoretical methods can be found in the Supplementary Materials section further below.

Catalyst preparation. Cu—CO₂ catalyst was prepared through an electrodeposition approach under CO₂ gas flow (50 standard cubic centimeters per minute, s.c.c.m.). The catalyst was electrodeposited at a constant current of −0.4 A cm⁻² for 60 s on a gas diffusion layer (Freudenberg H14C9) or polytetrafluoroethylene (PTFE) membrane (450 nm) with 50 nm sputtered Cu. The solution was consisted of 0.1 M copper bromide (98%, Sigma-Aldrich), 0.2 M sodium tartrate dibasic dihydrate (purum p.a., ≥98.0% NT, Sigma-Aldrich) and 1 M KOH. For Cu-HER, the catalyst was synthesized under identical conditions as Cu—CO₂ but with N₂ or Ar at the same flow rate to substitute CO₂.

For Ag catalysts, the precursor Ag₂O was prepared by mixing 25 mL 0.05 M AgNO₃ (98%, Sigma-Aldrich) with 1.4 g KOH. Then, the as-made Ag₂O particles were spray-coated on 1 cm² GDL with a mass loading of 0.3 mg cm⁻². Ag—CO₂ and Ag-HER catalysts were prepared by electroreducing Ag₂O nanoparticle at the constant current of −0.2 A cm⁻² for 30 s under CO₂ and N₂, respectively.

Material characterization. The crystal structures of the samples were characterized with a powder X-ray diffractometer (XRD, Bruker D8) using Cu-Kα radiation (λ=0.15406 nm). Scanning electron microscope (Hitachi S-5200) and transition electron microscope (Hitachi HF3300) were employed to observe the morphology of the samples. X-ray photoelectron spectroscopy (XPS) measurements were carried out on a K-Alpha XPS spectrometer (PHI 5700 ESCA System), using Al Kα X-ray radiation (1486.6 eV) for excitation. Operando hard X-ray absorption measurements were performed at the 9BM beamline of the Advanced Photon Source (APS) located in the Argonne National Laboratory (Lemont, Ill.). Grazing-Incidence Wide-Angle X-ray Scattering (GIWAX) measurements were conducted at the Hard X-ray MicroAnalysis (HXMA) beamline of the Canadian Light Source (CLS). Raman measurements were conducted using a Renishaw inVia Raman Microscope and a water immersion objective (63×) with a 785 nm laser.

Electrocatalytic measurement of CO₂ reduction. The electrocatalytic measurements were carried out in a gas-tight electrochemical flow cell using a three-electrode configuration with 90% iR correction. The flow cell was connected to an electrochemical workstation (Autolab PGSTAT204). The flow cell included three compartments: gas chamber, catholyte chamber, and anolyte chamber. The gas and cathodic compartments were separated by the Cu (or Ag) GDL electrode. Catholyte and anolyte chambers were separated by an anion-exchange membrane (Fumapem FAA-3-PK-130). The CO₂RR catalyst, Ag/AgCl electrode (3.5 M KCl used as the filling solution) and Ni mesh were employed as working, reference, and counter electrodes, respectively. The applied potentials were converted to the reversible hydrogen electrode (RHE) scale through the following equation:

E_{RHE}=E_{Ag/AgCl (3.5 M KCl)}+0.059×pH+0.205

Aqueous KOH electrolytes (1, 7 and 10 M) were used as the both catholyte and anolyte. The flow rate of the CO₂ gas transporting into the gas chamber was fixed at 50 s.c.c.m. The gaseous products of CO₂ reduction reaction were separated by gas chromatography (PerkinElmer Clarus 600), and detected by a thermal conductivity detector (TCD) and a flame ionization detector (FID). High-purity Argon (99.99%) was used as the carrier. Liquid products were quantified by H-nuclear magnetic resonance (H-NMR) technic (Agilent DD2 500) using Dimethyl sulfoxide (DMSO) as the internal standard. Faradaic efficiency of product x (FEₓ) was calculated based on the following equation:

$${FE}_{x} = \frac{{i}_{x}}{{i}_{tot}} = \frac{{n}_{x} {v}_{gas} {c}_{x} F}{{i}_{tot} {V}_{m}}$$

where iₓ is the partial current of product x; iₜₒₜ denotes the total current; nₓ represents the number of electron transfer towards the formation of 1 mol of product x; v_{gas} is the CO₂ flow rate (s.c.c.m); cₓ represents the concentration of product x detected by the gas chromatography (p.p.m); F is the Faraday constant (96,485 C·mol⁻¹); Vₘ is the unit molar volume, which is 24.5 L·mol⁻¹ at room temperature (298.15 K).

The half-cell power conversion efficiency (PCE) was defined as the ratio of fuel energy to applied electrical power, which was calculated with the following equation:

$${PCE}_{x} = \frac{{P}_{chem}}{{P}_{applied}} = \frac{( 1.23 - {E}_{x}^{0} ) {FE}_{x}}{1.23 - E}$$

where P_{chem} stands for the power used for the artificial carbon fixation; P_{applied} stands for the input electrical energy; E⁰ₓ represents the equilibrium potential of CO₂ electroreduction to each C₂₊ product, which is 0.08 V for ethylene, 0.09 V for ethanol, 0.21 V for n-propanol, and −0.26 V for acetate. FEₓ is the Faradaic efficiency for each C₂₊ product. 1.23 V is the equilibrium potential of water oxidation (i.e. assuming the overpotential of the water oxidation is zero). E is the applied potential vs. RHE after iR correction.

### Supplementary Material

The following supplemental material is provided related to tests, background, calculations, findings and experimental methods used in the present study.

Theoretical methods. In this work, all the DFT calculations were carried out with a periodic slab model using the Vienna ab initio simulation program (VASP). The generalized gradient approximation (GGA) was used with the Perdew-Burke-Ernzerhof (PBE) exchange-correlation functional. The projector-augmented wave (PAW) method was utilized to describe the electron-ion interactions, and the cut-off energy for the plane-wave basis set was 450 eV. In order to illustrate the long-range dispersion interactions between the adsorbates and catalysts, we employed the D3 correction method by Grimme et al. Brillouin zone integration was accomplished using a 3×3×1 Monkhorst-Pack k-point mesh.

All the adsorption geometries were optimized using a force-based conjugate gradient algorithm, while transition states (TSs) were located with a constrained minimization technique. For the modelling of copper, the crystal structure was optimized and the equilibrium lattice constants were found to be a_{Cu}=3.631 Å. Three low Miller index planes were cleaved, including Cu(100), Cu(111), and Cu(211). For Cu(100), a periodic six-layer model with the 3 lower layers fixed and 3 upper layers relaxed was used, and a p(3×3) super cell was chosen. For Cu(111), we used a 4-layer model with p(3×3) super cell with the 2 upper layers relaxed and 2 lower layers fixed. Cu(211) was modelled with a periodic 12-layer p(1×3) model with the 6 lower layers fixed and 6 upper layers relaxed. At all intermediate and transition states, one charged layer of water molecules was added to the surface to take the combined field and solvation effects into account. In the CO dimerization, there is no proton or electron transfer, thus the computational hydrogen electrode was not used in this work.

To evaluate the stability of one surface, the surface energy was used as defined below:

$${E}_{surface} = \frac{{E}_{total} - {nE}_{ref} - {E}_{ads}}{2 A}$$

where Eₜₒₜₐₗ is the total energy of this surface from DFT calculations, and E_{ref} is the reference energy of unit composition from bulk calculation. E_{ads} is the sum of the adsorption energies of the intermediates at given coverages. A and n are the surface area and the number of unit composition in this surface, respectively. Given this definition, the more positive the surface energy is for a surface, the less stable this surface is.

Wulff construction were performed using the Python Materials Genomics (pymatgen) materials analysis library. In this work, CO₂RR intermediates refer to CO₂*, CO*, COOH*, and H*, while HER intermediates are H*. Surface energies with adsorption of four intermediates states were calculated by assuming the coverages of all the four intermediates are the same. For example, the coverage of all the intermediates were assumed to be 0.05 ML for all the four intermediates at 0.2 ML total coverage. The total coverage value of CO₂RR intermediates, 0.2 ML, is chosen because it is the total coverage of each intermediate adsorbing on one side of a 3x3 surfaces. 211 surface is assumed to be have 9 sites to keep consistent 111 and 100. In realistic system, the coverage of the species should be larger, and the values for different intermediates should be diverse. Nørskov and co-workers reported the coverage of CO are -0.3 ML on Cu surfaces based on micro-kinetic modelling. The value 0.2 ML is considered only to show the trend that Cu(100) concentration increases even at low coverage of intermediates. The surface energies with intermediates are calculated in respect of Cu(111).

Electrochemical OH⁻ adsorption and ECSA evaluation. The electrochemical OH⁻ adsorption was performed in N₂-saturated 1 M KOH electrolyte by a linear sweep voltammetry method at a sweep rate of 100 mV s⁻¹ for Cu and 20 mV s⁻¹ for Ag catalysts. The potential was ranged from −0.2 to 0.6 V vs. RHE for Cu. All Cu catalysts were reduced at −0.6 V vs. RHE for 2 min before performing the OH⁻ adsorption measurement. For Ag, catalysts were first reduced at −0.6 V vs. RHE for 30 s, and the potential range was 0.83 to 0.93 V vs. RHE. For ECSA evaluation, electrochemical double layer capacitance method was employed. All catalysts were reduced at −0.6 V vs. RHE for 2 min, and scanned in the potential range of −0.2 to 0 V and 0.83 to 0.93 V vs. RHE for Cu and Ag catalysts in 1 M KOH at the sweep rate of 20, 40, 60, 80, and 100 mV s⁻¹. The double layer capacitance of electropolished Cu foil was obtained from previous report.

XAS fitting. An IFEFFIT package was used to analyze the hXAS spectra. Standard data-processing including energy calibration and spectral normalization of the raw spectra was performed using Athena software. To track the Cu valence distribution, a linear combination fitting analysis, included in Athena, was carried out using the hXAS spectra of various Cu-based standards. To extract the Cu bonding information, a Fourier transform was applied to convert the hXAS spectra from an energy space to a radial distance space. Then, a standard fitting analysis of the first shell between 1.6 and 3.0 Å was carried out using Artemis software. The phase and amplitude functions of Cu—Cu was calculated with FEFF, S0/σ2 values of 0.89/0.00825 for Cu was determined from Cu foil, which then was applied to the Cu hXAS fitting.

The following tables provide additional data and information regarding this work:

TABLE 1
Activation energies (Ea) and enthalpy changes (ΔH) of CO dimerization
on Cu(111), Cu(100), and Cu(211). All the energies are in eV.

| | Eₐ | ΔH |
|---|---|---|
| Cu(111) | 0.72 | 0.65 |
| Cu(100) | 0.66 | 0.30 |
| Cu(211) | 0.87 | 0.39 |

TABLE 2
Surface energies of Cu(111), Cu(100), Cu(211)
without and with adsorption of four intermediates in
CO₂ reduction. All the surface energies are in J/cm².

| | Without adsorption | With adsorption |
|---|---|---|
| Cu(111) | 1.43 | 1.15 |
| Cu(100) | 1.25 | 1.25 |
| Cu(211) | 1.55 | 1.31 |

TABLE 3
Adsorption energies of four intermediates
(CO₂*, COOH*, CO*, and H*) in CO₂ reduction on
Cu(111), Cu(100), Cu(211). All the energies are in eV.

| | Cu(100) | Cu(111) | Cu(211) |
|---|---|---|---|
| CO₂* | −0.44 | 0.32 | −0.32 |
| COOH* | −0.49 | 0.35 | −0.03 |
| CO* | −1.17 | −0.75 | −0.99 |
| H* | −0.29 | −0.24 | −0.43 |

TABLE 4
A summary of Faradaic efficiency for
all products on Cu—CO₂ in 10M KOH.

| Potential | Faradaic efficiency (%) | | | | | | | |
|---|---|---|---|---|---|---|---|---|
| (V vs. RHE) | H₂ | CO | CH₄ | C₂H₄ | HCOO⁻ | EtOH | AcO⁻ | Total |
| −0.15 | 4.4 | 9.5 | 1.0 | 0.8 | 0 | 0 | 0 | 16.7 |
| −0.18 | 7.4 | 17 | 0.6 | 1.5 | 0 | 0 | 0 | 26.5 |
| −0.20 | 8.5 | 26.1 | 0.4 | 2.7 | 0.8 | 0 | 0 | 38.5 |
| −0.25 | 6.2 | 47.5 | 0.3 | 7.0 | 3.8 | 0 | 6.5 | 71.3 |
| −0.27 | 6.8 | 36.4 | 0.05 | 13.7 | 6.0 | 4.0 | 4.7 | 71.7 |
| −0.33 | 8.3 | 30.0 | 0.1 | 22.8 | 5.1 | 4.9 | 6.8 | 78.0 |
| −0.38 | 4.7 | 22.1 | 0.02 | 46.9 | 4.3 | 6.7 | 8.0 | 92.7 |
| −0.44 | 4.5 | 10.9 | 0.05 | 60.0 | 2.2 | 9.4 | 7.7 | 94.8 |
| −0.50 | 3.8 | 4.4 | 0.04 | 71.4 | 2.3 | 8.5 | 9.2 | 99.6 |
| −0.56 | 8.5 | 2.0 | 0.15 | 70.1 | 1.8 | 12.9 | 5.9 | 101.4 |

TABLE 5
A summary of CO₂ electroreduction to C₂₊ products on different catalysts.

| | C₂₊ | C₂₊ partial current | C₂₊ half-cell power | |
|---|---|---|---|---|
| | Faradaic | density and | conversion efficiency | |
| | efficiency | corresponding potential | and corresponding | |
| Catalyst | (%) | (mA cm⁻²) | potential (%) | Reference |
| CO2RR- | 90 | 200/−0.56 V vs. RHE | 61/−0.5 V vs. RHE | This work |
| synthsized | | | 60/−0.56 V vs. RHE | |
| faceting | | | | |
| Abrupt Cu | 83 | ~220/−0.54 V vs. RHE | 54/−0.54 V vs. RHE | Ref. 22 |
| interface | | | | |
| Metal-ion | 60 | ~55/−0.96 V vs. RHE | 31/−0.96 V vs. RHE | Ref. 12 |
| cycling Cu | | | | |
| Cu₂S—Cu—V | 56 | ~220/−0.9 V vs. RHE | 34/−0.9 V vs. RHE | Ref. 10 |
| Electro- | 54 | 161/−1.0 V vs. RHE | 28/−1.0 V vs. RHE | Ref. 7 |
| redeposited | | | | |
| Cu | | | | |
| Cu—Ag | 85 | ~264/−0.7 V vs. RHE | 50/−0.7 V vs. RHE | Ref. 9 |
| nanowires | | | | |
| Porous Cu | 69 | ~130/−0.69 V vs. RHE | 41/−0.69 V vs. RHE | Ref. 6 |
| nanowires | | | | |

TABLE 6
A summary of Faradaic efficiency for
all products on Cu-HER in 10M KOH.

| Potential | Faradaic efficiency (%) | | | | | | | |
|---|---|---|---|---|---|---|---|---|
| (V vs. RHE) | H₂ | CO | CH₄ | C₂H₄ | HCOO⁻ | EtOH | AcO⁻ | Total |
| −0.15 | 11.0 | 6.7 | 0.4 | 0.5 | 0 | 0 | 0 | 7.6 |
| −0.18 | 11.3 | 11.9 | 0.6 | 1.0 | 0 | 0 | 0 | 13.5 |
| −0.20 | 10.5 | 15.1 | 0.4 | 1.7 | 1.6 | 0 | 0 | 29.3 |
| −0.25 | 16.3 | 26.5 | 0.3 | 4.5 | 4.2 | 0 | 0 | 51.8 |
| −0.27 | 17 | 29.3 | 0.5 | 8.1 | 7.3 | 2.0 | 4.0 | 68.2 |
| −0.33 | 13.0 | 19.8 | 0.3 | 22.6 | 7.0 | 3.6 | 5.5 | 71.8 |
| −0.38 | 13.0 | 22.1 | 0.7 | 34.2 | 6.3 | 4.2 | 6.0 | 86.5 |
| −0.44 | 13.7 | 7.0 | 0.1 | 53.3 | 5.0 | 5.9 | 5.0 | 90.0 |
| −0.50 | 13.0 | 6.5 | 0.2 | 56.8 | 4.5 | 6.5 | 5.2 | 93.4 |
| −0.58 | 26.0 | 5.5 | 1.3 | 51.7 | 3.3 | 7.1 | 5.0 | 99.9 |

TABLE 7
Extend X-ray absorption fine structure (EXAFS)
curve-fitting results for Cu—CO₂.

| Time (sec) | CN | R (Å) | σ² (10⁻³Å²) | ΔE₀ (eV) |
|---|---|---|---|---|
| 9 | 11.2 | 2.54 | 8.1 | −9.2 |
| 18 | 12.5 | 2.54 | 8.3 | −9.5 |
| 27 | 11.5 | 2.54 | 8.0 | −11.0 |
| 36 | 11.2 | 2.55 | 10.1 | −7.5 |
| 45 | 12.4 | 2.56 | 6.5 | −7.2 |
| 54 | 10.9 | 2.55 | 7.5 | −7.5 |
| 63 | 10.9 | 2.57 | 6.5 | −6.3 |

TABLE 8
Extend X-ray absorption fine structure (EXAFS)
curve-fitting results for Cu-HER.

| Time (sec) | CN | R (Å) | σ² (10⁻³Å²) | ΔE₀ (eV) |
|---|---|---|---|---|
| 9 | 11.4 | 2.54 | 4.2 | −7.7 |
| 18 | 11.0 | 2.54 | 8.1 | −10.1 |
| 27 | 11.0 | 2.54 | 8.5 | −0.84 |
| 36 | 11.3 | 2.55 | 7.6 | 0.17 |
| 45 | 11.2 | 2.56 | 8.0 | 1.13 |
| 54 | 10.5 | 2.55 | 8.1 | 0.86 |

The following is a list of references the entire contents of which are hereby incorporated herein by reference. It is also noted that the entire contents of all documents mentioned herein are incorporated herein by reference.
Bushuyev, O. S. et al. What should we make with CO₂ and how can we make it? Joule 2, 1-8 (2018).
Mistry, H., Varela, A. S., Kuhl, S., Strasser, P., & Cuenya, B. R. Nanostructured electrocatalysts with tunable activity and selectivity. Nat. Rev. Mater. 1, 16009 (2016).
Schouten, K., Kwon, Y., Van der Ham, C., Qin, Z., Koper, M. A new mechanism for the selectivity to C₁ and C₂ species in the electrochemical reduction of carbon dioxide on copper electrodes. Chem. Sci. 2, 1902-1909 (2011).
Hori, Y. in Modern aspects of electrochemistry, Berlin, Germany 89-189 (Springer, 2008).
Wang, Y., Liu, J., Wang, Y., Al-Enizi, A. M., Zheng, G. Tuning of CO₂ reduction selectivity on metal electrocatalysts. Small 13, 1701809 (2017).
Hoang, T. T. H., Ma, S., Gold, J. I., Kenis, P. J. A., Gewirth, A. A. Nanoporous copper films by additive-controlled electrodepsition: CO₂ reduction catalysis. ACS Catal. 7. 3313-3321 (2017). (Ref. 6)
De Luna, P. et al. Catalyst electro-redeposition controls morphology and oxidation state for selective carbon dioxide reduction. Nat. Catal. 1, 103-110 (2018). (Ref. 7)
Mistry, H. et al. Highly selective plasma-activated copper catalysts for carbon dioxide reduction to ethylene. Nat. Commun. 7, 12123 (2016).
Hoang, T. T. H et al. Nano porous copper-silver alloys by additive-controlled electro-deposition for the selective electroreduction of CO₂ to ethylene and ethanol. J. Am. Chem. Soc. 140, 5791-5797 (2018). (Ref. 9)
Zhuang, T.-T. et al. Steering post-C-C coupling selectivity enables high efficiency electroreduction of carbon dioxide to multi-carbon alcohols. Nat. Catal. 1, 421-428 (2018). (Ref. 10)
Li, C. W., Ciston, J., Kanan, M. W. Electroreduction of carbon monoxide to liquid fuel on oxide-derived nanocrystalline copper. Nature 508, 504-507 (2014).
Jiang, K. et al. Metal ion cycling of Cu foil for selective C—C coupling in electrochemical CO₂ reduction. Nat. Catal. 1, 111-119 (2018). (Ref. 12)
Li, C. W., Kanan, M. W. CO₂ reduction at low overpotential on Cu electrodes resulting from the reduction of thick Cu₂O films. J. Am. Chem. Soc. 134, 7231-7234 (2012).
Reller, C. et al. Selective electroreduction of CO₂ toward ethylene on nano dendritic copper catalysts at high current density. Adv. Energy Mater. 7, 1602114 (2017).
Schouten, K. J. P., Qin, Z., Pérez Gallent, E., Koper, M. Two pathways for formation of ethlyene in CO reduction on signle-crystal copper electrodes. J. Am. Chem. Soc. 134, 9864-9867 (2012).
Pérez Gallent, E., Figueiredo, M. C., Calle-Vallejo, F., Koper, M. Spectroscopic observation of a hydrogenated CO dimer intermediate during CO reduction on Cu(100) electrodes. Angew. Chem. Int. Ed. 56, 3621-3624 (2017).
Hori, Y., Takahashi, I., Koga, O., & Hoshi, N. Electrochemical reduction of carbon dioxide at various series of copper single crystal electrodes. J. Mol. CataL A: Chem. 199, 39-47 (2003).
Jin, M. et al. Shape-controlled synthesis of copper nanocrystals in an aqueous solution with glucose as a reducing agent and hexadecylamine as a capping agent. Angew. Chem. Int. Ed. 50, 10560-10564 (2011).
Tran, R. et al. Surface energies of elemental crystals. Sci. Data 3, 160080 (2016).
Droog, J. M. M., & Schlenter, B. Oxygen electrosorption on copper single crystal electrodes in sodium hydroxide solution. J. Electroanal. Chem. 112, 387-390 (1980).
Raciti, D. et al Low-overpotential electroreduction of carbon monoxide using copper nanowires. ACS CataL 7, 4467-4472 (2017).
Dinh, C.-T. et al. Sustained high-selectivity CO₂ electroreduction to ethylene via hydroxide-mediated catalysis at an abrupt reaction interface. Science 360, 783-787 (2018). (Ref. 22)
Liu, M. et al. Enhanced electrocatalytic CO₂ reduction via field-induced reagent concentration. Nature 537, 382-386 (2016).
Chen, Y., Li, C. W., Kanan, M. W. Aqueous CO₂ reduction at very low overpotential on oxide-derived Au nanoparticles. J. Am. Chem. Soc. 134, 19969-19972 (2012).
Lei, F. et al. Metallic tin quantum sheets confined in graphene toward high-efficiency carbon dioxide electroreduction. Nat. Commun. 7, 12697 (2016).
Salehi-Khojin, A. et al. Nanoparticle silver catalysts that show enhanced activity for carbon dioxide electrolysis. J. Phys. Chem. C 117, 1627-1632 (2013).
Huang, H. et al. Understanding of strain effects in the electrochemical reduction of CO_{2:} using Pd nanostructures as an ideal platform. Angew. Chem. Int. Ed. 56, 3594-3598 (2017).
Zhang, S., Kang, P., Meyer, T. J. Nanostructured tin catalysts for selective electrochemical reduction of carbon dioxide to formate. J. Am. Chem. Soc. 136, 1734-1737 (2014).
Cheng, T., Xiao, H. & Goddard, W. A. Nature of the active sites for CO reduction on copper nanoparticles; suggestions for optimizing performance. J. Am. Chem. Soc. 139, 11642-11645 (2017).
Kim, Y.-G., Baricuatro, J. H., Javier, A., Gregoire, J. M., & Soriaga, M. P. The evolution of the polycrystalline copper surface, first to Cu(111) and the to Cu(100), at a fixed CO₂RR potential: a study by operando EC-STM. Langmiur 30, 15053-15056 (2014).
Gunathunge, C. M. et al. Spectroscopic observation of reversible surface reconstruction of copper electrodes under CO₂ reduction. J. Phys. Chem. C. 121, 12337-12344 (2017).
Reske, R., Mistry, H., Behafarid, F., Roldan Cuenya, B., Strasser, P. Size effects in the catalytic electroreduction of CO₂ on Cu nanoparticles. J. Am. Chem. Soc. 136, 6978-6986 (2014).
Kresse, G., Furthmüller, J. Efficient iterative schemes for ab initio total-energy calculations using a plane-wave basis set. Phys. Rev. B 54, 11169-11186 (1996).
Kresse, G., Furthmuller, J. Efficiency of ab-initio total energy calculations for metals and semiconductors using a plane-wave basis set. Comp. Mater. Sci. 6, 15-50 (1996).
Kresse, G., Hafner, J. Ab-Initio Molecular-Dynamics Simulation of the Liquid-Metal Amorphous-Semiconductor Transition in Germanium. Phys. Rev. B 49, 14251-14269 (1994).
Kresse, G.. Hafner, J. Ab initio molecular dynamics for liquid metals. Phys. Rev.

B 47, 558-561 (1993).
Perdew, J. P., Burke, K., Ernzerhof, M. Generalized Gradient Approximation Made Simple. Phys. Rev. Lett. 77, 3865-3868 (1996).
Kresse, G., Joubert, D. From ultrasoft pseudopotentials to the projector augmented-wave method. Phys. Rev. B 59, 1758-1775 (1999).
Blöchl, P. E. Projector augmented-wave method. Phys. Rev. B 50, 17953-17979 (1994).
Grimme, S., Antony, J., Ehrlich, S., Krieg, H. A consistent and accurate ab initio parametrization of density functional dispersion correction (DFT-D) for the 94 elements H-Pu. J. Chem. Phys. 132, 154104 (2010).
Michaelides, A. et al. Identification of general linear relationships between activation energies and enthalpy changes for dissociation reactions at surfaces. J. Am. Chem. Soc. 125, 3704-3705 (2003).
Liu, Z. P., Hu, P. General rules for predicting where a catalytic reaction should occur on metal surfaces: A density functional theory study of C—H and C—O bond breaking/making on flat, stepped, and kinked metal surfaces. J. Am. Chem. Soc. 125, 1958-1967 (2003).
Alavi, A., Hu, P. J., Deutsch, T., Silvestrelli, P. L., Hutter, J. CO oxidation on Pt(111): An ab initio density functional theory study. Phys. Rev. Lett. 80, 3650-3653 (1998).
Montoya, J. H., Shi, C., Chan, K., Nørskov, J. K. Theoretical Insights into a CO Dimerization Mechanism in CO₂ Electroreduction. J. Phys. Chem. Lett. 6, 2032-2037 (2015).
Ong, S. P. et al. Python Materials Genomics (pymatgen): A robust, open-source python library for materials analysis. Comp. Mater. Sci. 68, 314-319 (2013).
Liu, X. et al. Understanding trends in electrochemical carbon dioxide reduction rates. Nat. Commun. 8, 15438 (2017).
Verdaguer-Casadevall, A. et al. Probing the active surface sites for CO reduction on oxide-derived electrocatalysts. J. Am. Chem. Soc. 137, 9808-9811 (2015).
Ravel, B., and Newville, M. ATHENA, ARTEMIS, HEPHAESTUS: data analysis for X-ray absorption spectroscopy using IFEFFIT. J. Synchrotron Rad. 12, 537-541 (2005).
Li, J., Liu, C.-H., Banis, M. N., Vaccarello, D., Ding, Z.-F., Wang, S.-D., Sham, T.-K. Revealing the Synergy of Mono/Bimetallic PdPt/TiO₂ Heterostructure for Enhanced Photoresponse Performance J. Phys. Chem. 121, 24861-24870 (2017).
Droog, J. M. M. Oxygen electrosorption on Ag(111) and Ag(110) electrodes in NaOH solution. J. Electroanal. Chem. 115, 225-233 (1980).

1-41. (canceled)

42. A method of preparing an electrocatalyst, being a metal catalyst material, comprising in-situ electrodeposition of the catalytic metal in the presence of CO₂ and/or CO under electroreduction conditions, wherein the catalytic metal comprising polycrystalline copper (Cu) or silver (Ag) is electrodeposited onto a substrate comprising a gas diffusion layer; wherein the catalytic metal is formed from electrodeposition from a catholyte solution comprising a salt of the catalytic metal, at least one complexing agent, and an alkali metal hydroxide and wherein the complexing agent is one or more of ammonia, ethylenediamine, tartrate acid, tartrate acid salts, citric acid, citric acid salts, ethylenediaminetetraacetic acid, ethylenediaminetetraacetic acid salts.

43. The method of claim 42, wherein the gas diffusion layer includes a metal seed layer disposed thereon, so that the catalytic metal is electrodeposited as an active catalyst layer onto the metal seed layer.

44. The method of claim 42, wherein the salt of the catalytic metal is one or more of sulfate, acetate, nitrate, halides, acetylacetonate, perchlorate, hydroxide, carbonate basic, and/or tartrate hydrate of the metal.

45. The method of claim 42, further comprising:
providing the catholyte in a cathodic chamber;
providing an anolyte in an anodic chamber separated from the cathodic chamber via a separator;
providing a counter electrode in the anodic chamber;
feeding the CO₂ into the cathodic chamber during the electrodeposition; and
providing a potential for the electrodeposition.

46. The method of claim 42 comprising:
preparing a catalyst precursor;
disposing the catalyst precursor onto the substrate comprising a gas diffusion layer; and
subjecting the deposited catalyst precursor to electroreduction conditions in the presence of CO₂ and/or CO to form the electrocatalyst on the substrate.

47. The method of claim 46, wherein the catalyst precursor comprises Ag₂O and the electrocatalyst comprises silver (Ag) including exposed Ag(110) facets.

48. The method of claim 46 wherein the catalyst precursor comprises a copper (Cu) oxide and the electrocatalyst comprises Cu including exposed Cu(100) facets.

49. An electrocatalyst for electroreduction of CO₂ and/or CO to generate products, the electrocatalyst comprising a metal catalyst material being in situ faceted to include exposed active facets presenting a highest selectivity of the corresponding metal for production of a target hydrocarbon product from electroreduction of CO₂ and/or CO, wherein the metal catalyst material comprises polycrystalline copper (Cu) and the exposed active facets are Cu(100) facets; wherein comprises exposed Cu(100) facets corresponding to an OH-electroadsorption charge distribution Cu(100)/Cu(111) ratio of at least 1.2; wherein the electrocatalyst is formed as an active catalyst layer on a Cu seed layer; and wherein the active catalyst layer has a thickness between 100 nm and 1000 nm.

50. The electrocatalyst of claim 49, wherein the Cu catalyst material has a crystal size between about 15 nm and about 100 nm, according to scanning electron microscopy (SEM).

51. The electrocatalyst of claim 49, wherein comprises exposed Cu(100) facets corresponding to an OH-electroadsorption charge distribution Cu(100)/Cu(111) ratio of at least 1.3 as determined by OH-electroadsorption.

52. The electrocatalyst of claim 49, wherein the Cu seed layer is disposed on a gas diffusion layer.

53. An electrocatalyst for electroreduction of CO₂ and/or CO to generate products, the electrocatalyst comprising a metal catalyst material being in situ faceted to include exposed active facets presenting a highest selectivity of the corresponding metal for production of a target hydrocarbon product from electroreduction of CO₂ and/or CO, wherein the metal catalyst material comprises silver (Ag) and the exposed active facets are Ag(110) facets; wherein the Ag catalyst material has exposed Ag(110) facets corresponding to an area of at least 2.5 cm² Ag(110) facets normalized to 1 cm² according to electrochemical hydroxide adsorption.

54. The electrocatalyst of claim 53, wherein the Ag catalyst material has exposed Ag(110) facets corresponding to:
(i) an area of at least 2.6 cm² Ag(110) facets normalized to 1 cm² according to electrochemical hydroxide adsorption;
(ii) an at least 1.5-fold increase in the area of Ag(110) facets compared to a corresponding catalyst synthesized using H2 evolution only by replacing the CO₂ with N₂; and/or
(iii) an amount enabling electroreduction of CO₂ into CO with Faradaic efficiency for CO of at least about 75%, and half-cell CO power conversion efficiency of 54% at 260 mA cm⁻².

55. A precursor composition for making an electrocatalyst, the precursor comprising:
an aqueous medium;
metal ions dissolved in the aqueous medium and provided by a metal salt; wherein the metal salt is provided at a concentration of 0.05 to 0.15 M and a complexing agent in the aqueous medium for stabilizing the metal ions; wherein the complexing agent comprises one or more of ammonia, ethylenediamine, tartrate acid, tartrate acid salts, citric acid, citric acid salts, ethylenediaminetetraacetic acid, ethylenediaminetetraacetic acid salts; wherein the complexing agent is at a concentration that is greater than the concentration of the metal salt;
one or more alkali metal hydroxides wherein the alkali metal hydroxide is provided in a concentration between 1 to 10 M; and
wherein the precursor composition is formulated such that the electroreduction conditions in the presence of CO₂ and/or CO enables the metal ions to deposit on the substrate to have exposed target facets.

56. The precursor composition of claim 55, wherein the metal salt is one or more of sulfate, acetate, nitrate, halides, acetylacetonate, perchlorate, hydroxide, carbonate basic, and/or tartrate hydrate of the metal.

57. The precursor composition of claim 55, wherein the metal is Cu and the Cu ions are provided by a Cu salt that includes CuBr₂.

58. The precursor composition of claim 55, wherein the complexing agent comprising tartrate acid salts being sodium tartrate.

59. A method of reactivating an electrocatalyst that has operated under electroreduction conditions, comprising:
adding a precursor composition to a catholyte solution, the precursor composition comprising metal ions or a metal salt to form the metal ions, a complexing agent for stabilizing the metal ions dissolved in the catholyte, thereby forming a reactivation catholyte solution; the precursor composition of claim 55 is added to or used as the catholyte solution;
applying a constant potential or current to the electrocatalyst in the presence of CO₂ and/or CO under electroreduction conditions to cause electrodeposition of at least a portion of the metal ions onto the electrocatalyst to form a catalytic metal thereon.

60. The method of claim 59, further comprising preparing a precursor mixture, directly adding the precursor mixture to the catholyte, operating under electroreduction conditions to produce C2+ hydrocarbons while reactivating the electrocatalyst.

61. The method of claim 59, wherein the catholyte is in a cathodic chamber; an anolyte is in an anodic chamber separated from the cathodic chamber via a separator;
electrodes are in the cathodic and anodic chambers respectively; and the CO₂ is fed into the cathodic chamber during the electrodeposition for reactivation wherein:
i) the anolyte is provided with the same amount of alkali metal hydroxides as the catholyte; and/or
ii) the electrode in the anodic chamber comprises a material selected from one or more of Ni, Pt and/or Au; and/or
iii) the separator comprises an anion-exchange membrane or a Nafion membrane.
